(19) United States
(12) Patent Application Publication
(10) Pub. No.: US 2011/0047155 A1
(43) Pub. Date: Feb. 24, 2011

(54) MULTIMEDIA ENCODING METHOD AND DEVICE BASED ON MULTIMEDIA CONTENT CHARACTERISTICS, AND A MULTIMEDIA DECODING METHOD AND DEVICE BASED ON MULTIMEDIA

(75) Inventors: Yu-Mi Sohn, Seoul (KR); Hae-Kyung Jung, Seoul (KR); Young-Yoon Lee, Suwon-si (KR); Han-Gil Moon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/988,426

(22) PCT Filed: Apr. 16, 2009
(86) PCT No.: PCT/KR2009/001954

§ 371 Date: Oct. 18, 2010

Related U.S. Application Data
(60) Provisional application No. 61/071,213, filed on Apr. 17, 2008.

(30) Foreign Application Priority Data
Apr. 15, 2009 (KR) 10-2009-0032757

(51) Int. Cl. G06F 17/30

(52) U.S. Cl. 707/736; 707/E17.014

(57) ABSTRACT

Metadata includes information for effectively presenting content, and the information included in the metadata includes some information useful for encoding or decoding of multimedia data. Thus, although syntax information of the metadata is provided for an information search, an increase of encoding or decoding efficiency of data can be achieved by using strong connection between the syntax information and the data.

### CROSS-REFERENCE TO RELATED APPLICATIONS

This is a National Stage application under 35 U.S.C. §371 of International Application No. PCT/KR2009/001954, filed on Apr. 16, 2009, which claims priority from Korean Patent Application No. 10-2009-0032757, filed on Apr. 15, 2009 in the Korean Intellectual Property Office, and U.S. Provisional Application No. 61/071,213, filed on Apr. 17, 2008 in the U.S. Patent and Trademark Office, the disclosures of which are incorporated herein by reference in their entireties.

### BACKGROUND

1. Field

Apparatuses and methods consistent with the exemplary embodiments relate to encoding or decoding of multimedia based on attributes of multimedia content.

2. Description

A descriptor of multimedia includes technology associated with attributes of content for information search or management of the multimedia. A descriptor of Moving Picture Experts Group-7 (MPEG-7) is representatively used. A user can receive various types of information regarding multimedia according to an MPEG-7 image encoding/decoding scheme using the MPEG-7 descriptor and search for desired multimedia.

### SUMMARY

Exemplary embodiments overcome the above disadvantages, as well as other disadvantages not described above. Also, the exemplary embodiments are not required to overcome the disadvantages described above, and an exemplary embodiment may not overcome any of the problems described above.

According to an aspect of an exemplary embodiment, there is provided a method of encoding multimedia data based on attributes of multimedia content, including: receiving the multimedia data; detecting attribute information of the multimedia data based on the attributes of the multimedia content; and determining an encoding scheme of encoding the multimedia data based on the detected attribute information.

The multimedia encoding method may further include: encoding the multimedia data according to the encoding scheme; and generating a bitstream including the encoded multimedia data.

The multimedia encoding method may further include encoding the attribute information of the multimedia data as a descriptor for management or search of the multimedia data, wherein the generating of the bitstream comprises generating a bitstream comprising the encoded multimedia data and the descriptor.

The predetermined attributes may include at least one of color attributes of image data, texture attributes of image data, and speed attributes of sound data, and the detecting of the attribute information may include detecting at least one of the color attributes of image data, the texture attributes of image data, and the speed attributes of sound data.

The color attributes of image data may include at least one of a color layout of an image and an accumulated distribution per color bin.

The determining of the encoding scheme may include measuring a variation between a pixel value of current image data and a pixel value of reference image data by using the color attributes of the image data.

The determining of the encoding scheme may further include compensating for the pixel value of the current image data by using the variation between the pixel value of the current image data and the pixel value of the reference image data.

The multimedia encoding method may further include compensating for the variation of the pixel values for the current image data for which motion compensation has been performed and encoding the current image data.

The multimedia encoding method may further include encoding at least one of metadata regarding a color layout, metadata regarding a color structure, and metadata regarding a scalable color to indicate the color attributes of the image data, as the descriptor for management or search of the multimedia based on the multimedia content.

The texture attributes of the image data may include at least one of homogeneity, smoothness, regularity, edge orientation, and coarseness of image texture.

The determining of the encoding scheme may include determining a size of a data processing unit for motion estimation of current image data by using the texture attributes of the image data.

The determining of the encoding scheme may include determining the size of the data processing unit based on the homogeneity of the texture attributes of the image data so that the more homogeneous the current image data is, the more the size of the data processing unit increases.

The determining of the encoding scheme may include determining the size of the data processing unit based on the smoothness of the texture attributes of the image data so that the smoother the current image data is, the more the size of the data processing unit increases.

The determining of the encoding scheme may include determining the size of the data processing unit based on the regularity of the texture attributes of the image data so that a texture change of the current image decreases as the size of the data processing unit increases.

The multimedia encoding method may further include performing motion estimation or motion compensation for the current image data by using the data processing unit of which the size is determined for the image data.

The determining of the encoding scheme may include determining a predictable intra prediction mode for the current image data by using the texture attributes of the image data.

The determining of the encoding scheme may include determining a type and a priority of a predictable intra prediction mode for the current image data based on the edge orientation of the texture attributes of the image data.

The multimedia encoding method may further include performing motion estimation for the current image data by using the intra prediction mode determined for the current image data.

The multimedia encoding method may further include encoding at least one of metadata regarding an edge histogram, metadata for texture browsing, and metadata regarding homogeneity of texture to indicate the texture attributes of the image data, as the descriptor for management or search of the multimedia based on the multimedia content.

The detecting of the attribute information may include analyzing and detecting speed attributes of sound data as the predetermined attributes of the multimedia content.

The speed attributes of the sound data may include tempo information of sound data.

The determining of the encoding scheme may include determining a length of a data processing unit for frequency transform of current sound data by using the speed attributes of the sound data.

The determining of the encoding scheme may include determining the length of the data processing unit to decrease as the current sound data increases, based on the tempo information of the speed attributes of the sound data.

The multimedia encoding method may further include performing frequency transform for the current sound data by using the data processing unit of which the length is determined for the sound data.

The multimedia encoding method may further include encoding at least one of metadata regarding audio tempo, semantic description information, and side information to indicate the speed attributes of the sound data, as the descriptor for management or search of the multimedia based on the multimedia content.

The determining of the encoding scheme may include determining a length of a data processing unit for frequency transform of current sound data as a fixed length when valid information is not extracted as the speed attributes of the sound data.

According to another aspect of an exemplary embodiment, there is provided a method of decoding multimedia data based on attributes of multimedia content, including: receiving a bitstream of encoded multimedia data; parsing the received bitstream; classifying encoded data of the multimedia data and information regarding the multimedia data based on the parsed bitstream; extracting attribute information for management or search of the multimedia data from the information regarding the multimedia; and determining a decoding scheme of decoding the multimedia data based on the extracted attribute information.

The multimedia decoding method may further include: decoding the encoded data of the multimedia according to the decoding scheme; and restoring the decoded multimedia data as the multimedia data.

The extracting of the attribute information may include: extracting a descriptor for management or search of the multimedia based on the multimedia content; and extracting the attribute information from the descriptor.

The predetermined attributes may include at least one of color attributes of image data, texture attributes of image data, and speed attributes of sound data, and the extracting of the attribute information may include extracting at least one of the color attributes of image data, the texture attributes of image data, and the speed attributes of sound data.

The determining of the decoding scheme may include measuring a variation between a pixel value of current image data and a pixel value of reference image data by using the color attributes of the image data.

The multimedia decoding method may further include: performing motion compensation of inverse-frequency-transformed current image data; and compensating for the pixel value of the current image data for which the motion compensation has been performed by using the variation between the pixel value of the current image data and the pixel value of the reference image data.

The extracting of the attribute information may include: extracting at least one of metadata regarding a color layout, metadata regarding a color structure, and metadata regarding a scalable color by parsing the bitstream; and extracting the color attributes of the image data from the extracted at least one descriptor.

The extracting of the attribute information may include extracting texture attributes of image data as the predetermined attributes of the multimedia content.

The determining of the decoding scheme may include determining the size of a data processing unit for motion estimation of current image data by using the texture attributes of the image data.

The determining of the decoding scheme may include determining the size of the data processing unit based on homogeneity of the texture attributes of the image data so that the more homogeneous the current image data is, the more the size of the data processing unit increases.

The determining of the decoding scheme may include determining the size of the data processing unit based on smoothness of the texture attributes of the image data so that the smoother the current image data is, the more the size of the data processing unit increases.

The determining of the decoding scheme may include determining the size of the data processing unit based on regularity of the texture attributes of the image data so that the more regular a pattern of the current image data is, the more the size of the data processing unit increases.

The multimedia decoding method may further include performing motion estimation or motion compensation for the current image data by using the data processing unit of which the size is determined for the image data.

The determining of the decoding scheme may include determining a predictable intra prediction mode for the current image data by using the texture attributes of the image data.

The determining of the decoding scheme may include determining a type and a priority of a predictable intra prediction mode for the current image data based on edge orientation of the texture attributes of the image data.

The multimedia decoding method may further include performing motion estimation for the current image data by using the intra prediction mode determined for the current image data.

The extracting of the attribute information may include: extracting at least one of metadata regarding an edge histogram, metadata for texture browsing, and metadata regarding homogeneity of texture from the descriptor by parsing the bitstream; and extracting the texture attributes of the image data from the extracted at least one descriptor.

The extracting of the attribute information may include extracting speed attributes of sound data as the predetermined attributes of the multimedia content.

The determining of the decoding scheme may include determining a length of a data processing unit for inverse frequency transform of current sound data by using the speed attributes of the sound data.

The determining of the decoding scheme may include determining the length of the data processing unit to decrease as the current sound data increases, based on the tempo information of the speed attributes of the sound data.

The multimedia decoding method may further include performing inverse frequency transform for the current sound data by using the data processing unit of which the length is determined for the sound data.

The extracting of the attribute information may include: extracting at least one of metadata regarding audio tempo, semantic description information, and side information from the descriptor by parsing the bitstream; and extracting the speed attributes of the sound data from the extracted at least one descriptor.

The determining of the decoding scheme may include determining a length of a data processing unit for inverse frequency transform of current sound data as a fixed length when valid information is not extracted as the speed attributes of the sound data.

According to an aspect of an exemplary embodiment, there is provided an apparatus that encodes multimedia data based on attributes of multimedia content, including: an input unit that receives the multimedia data; an attribute information detector that detects attribute information of the multimedia data based on the attributes of the multimedia content; an encoding scheme determiner that determines an encoding scheme of encoding the multimedia data based on the detected attribute information; and a multimedia data encoder that encodes the multimedia data according to the encoding scheme.

The multimedia encoding apparatus may further include a descriptor encoder that encodes the attribute information for management or search of the multimedia into a descriptor.

According to an aspect of an exemplary embodiment, there is provided an apparatus for decoding multimedia data based on attributes of multimedia content, including: a receiver that receives a bitstream of encoded multimedia data, parses the received bitstream, and classifies encoded multimedia data and information regarding the multimedia based on the parsed bitstream; an attribute information extractor that extracts attribute information for management or search of the multimedia data from the information regarding the multimedia; a decoding scheme determiner that determines a decoding scheme of decoding the multimedia data based on the extracted attribute information; and a multimedia data decoder that decodes the encoded multimedia data according to the decoding scheme.

The multimedia decoding apparatus may further include a restorer that restores the decoded multimedia data as the multimedia data.

According to an aspect of an exemplary embodiment, there is provided a computer readable recording medium storing a computer readable program for executing the method of encoding multimedia based on attributes of multimedia content.

According to an aspect of an exemplary embodiment, there is provided a computer readable recording medium storing a computer readable program for executing the method of decoding multimedia based on attributes of multimedia content.

### BRIEF DESCRIPTION OF THE DRAWINGS

FIG. 1 is a block diagram of a multimedia encoding apparatus based on attributes of multimedia content, according to an exemplary embodiment of the present invention;

FIG. 2 is a block diagram of a multimedia decoding apparatus based on attributes of multimedia content, according to an exemplary embodiment of the present invention;

FIG. 3 is a block diagram of a typical video encoding apparatus;

FIG. 4 is a block diagram of a related art video decoding apparatus;

FIG. 5 is a block diagram of a multimedia encoding apparatus based on color attributes of multimedia, according to an exemplary embodiment;

FIG. 6 is a block diagram of a multimedia decoding apparatus based on color attributes of multimedia, according to an exemplary embodiment;

FIG. 7 illustrates a brightness change between consecutive frames, which is measured using color attributes, according to the exemplary embodiment;

FIG. 8 illustrates a color histogram used as color attributes, according to the exemplary embodiment;

FIG. 9 illustrates a color layout used as color attributes, according to the exemplary embodiment;

FIG. 10 is a flowchart of a multimedia encoding method based on color attributes of multimedia, according to the exemplary embodiment;

FIG. 11 is a flowchart of a multimedia decoding method based on color attributes of multimedia, according to the exemplary embodiment;

FIG. 12 is a block diagram of a multimedia encoding apparatus based on texture attributes of multimedia, according to an exemplary embodiment;

FIG. 13 is a block diagram of a multimedia decoding apparatus based on texture attributes of multimedia, according to the exemplary embodiment;

FIG. 14 illustrates types of a prediction mode used in a related art video encoding method;

FIG. 15 illustrates types and groups of a prediction mode available in the exemplary embodiment;

FIG. 16 illustrates a method of determining a data processing unit using texture, according to the exemplary embodiment;

FIG. 17 illustrates edge types used as texture attributes, according to the exemplary embodiment;

FIG. 18 illustrates an edge histogram used as texture attributes, according to the exemplary embodiment;

FIG. 19 is a flowchart of a multimedia encoding method based on texture attributes of multimedia, according to the exemplary embodiment;

FIG. 20 is a flowchart of a multimedia decoding method based on texture attributes of multimedia, according to the exemplary embodiment;

FIG. 21 is a block diagram of a multimedia encoding apparatus based on texture attributes of multimedia, according to an exemplary embodiment;

FIG. 22 is a block diagram of a multimedia decoding apparatus based on texture attributes of multimedia, according to the exemplary embodiment;

FIG. 23 illustrates a relationship among an original image, a sub image, and an image block;

FIG. 24 illustrates semantics of an edge histogram descriptor of a sub image;

FIG. 25 is a table of intra prediction modes of the related art video encoding method;

FIG. 26 illustrates directions of the intra prediction modes of the related art video encoding method;

FIG. 27 is a reconstructed table of intra prediction modes, according to the exemplary embodiment;

FIG. 28 is a flowchart of a multimedia encoding method based on texture attributes of multimedia, according to the exemplary embodiment;

FIG. 29 is a flowchart of a multimedia decoding method based on texture attributes of multimedia, according to the exemplary embodiment;

FIG. 30 is a block diagram of a multimedia encoding apparatus based on speed attributes of multimedia, according to an exemplary embodiment;

FIG. 31 is a block diagram of a multimedia decoding apparatus based on speed attributes of multimedia, according to the exemplary embodiment;

FIG. 32 is a table of windows used in a related art audio encoding method;

FIG. 33 illustrates a relationship of adjusting a window length based on tempo information of sound, according to the exemplary embodiment;

FIG. 34 is a flowchart of a multimedia encoding method based on speed attributes of multimedia, according to the exemplary embodiment;

FIG. 35 is a flowchart of a multimedia decoding method based on speed attributes of multimedia, according to the exemplary embodiment;

FIG. 36 is a flowchart of a multimedia encoding method based on attributes of multimedia content, according to an exemplary embodiment; and

FIG. 37 is a flowchart of a multimedia decoding method based on attributes of multimedia content, according to an exemplary embodiment.

### DETAILED DESCRIPTION OF EXEMPLARY EMBODIMENTS

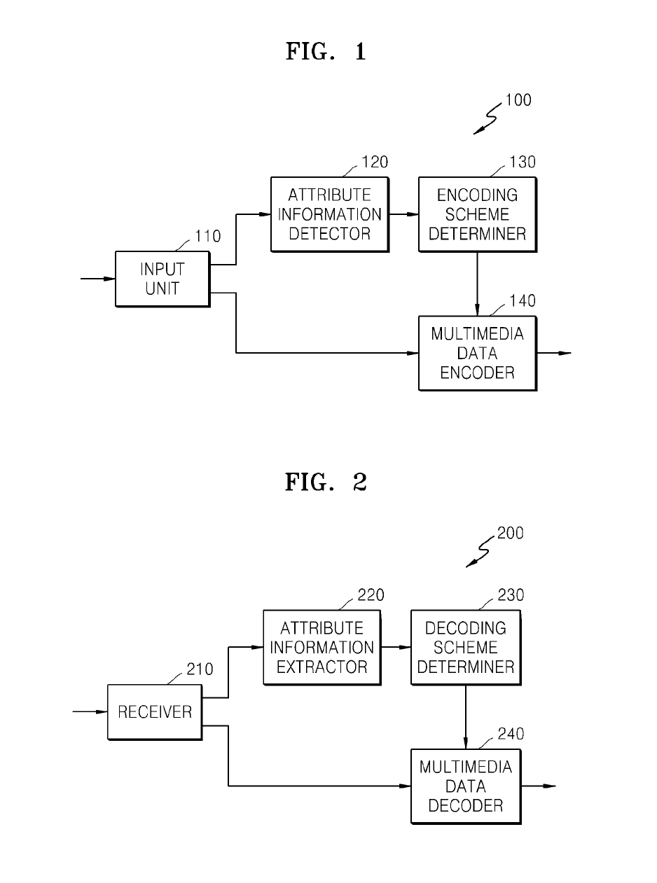

A multimedia encoding method, a multimedia encoding apparatus, a multimedia decoding method, and a multimedia decoding apparatus, according to exemplary embodiments, will now be described in detail with reference to FIGS. 1 to 37. In the following description, the same drawing reference numerals are used for the same elements even in different drawings.

Metadata includes information for effectively presenting content, and the information included in the metadata includes some information useful for encoding or decoding of multimedia data. Thus, although syntax information of the metadata is provided for an information search, an increase of encoding or decoding efficiency of sound data can be contrived by using strong connection between the syntax information and sound data.

A multimedia encoding apparatus and a multimedia decoding apparatus can be applied to a video encoding/decoding apparatus based on spatial prediction or temporal prediction or to every image processing method and apparatus using the video encoding/decoding apparatus. For example, a process of the multimedia encoding apparatus and the multimedia decoding apparatus can be applied to mobile communication devices such as a cellular phone, image capturing devices such as a camcorder and a digital camera, multimedia reproducing devices such as a multimedia player, a Portable Multimedia Player (PMP), and a next generation Digital Versatile Disc (DVD), and software video codecs.

In addition, the multimedia encoding apparatus and the multimedia decoding apparatus can be applied to not only current image compression standards such as MPEG-7 and H.26X but also next generation image compression standards. The process of the multimedia encoding apparatus and the multimedia decoding apparatus can be applied to media applications providing not only an image compression function but also a search function used simultaneously with or independently from image compression.

FIG. 1 is a block diagram of a multimedia encoding apparatus 100, according to an exemplary embodiment.

The multimedia encoding apparatus 100 includes an input unit 110, an attribute information detector 120, an encoding scheme determiner 130, and a multimedia data encoder 140.

The input unit 110 receives multimedia data and outputs the multimedia data to the attribute information detector 120 and the multimedia data encoder 140. The multimedia data can include image data and sound data.

The attribute information detector 120 detects attribute information for management or search of multimedia based on predetermined attributes of multimedia content by analyzing the multimedia data. According to an exemplary embodiment, the predetermined attributes of multimedia content can include color attributes of image data, texture attributes of image data, and speed attributes of sound data.

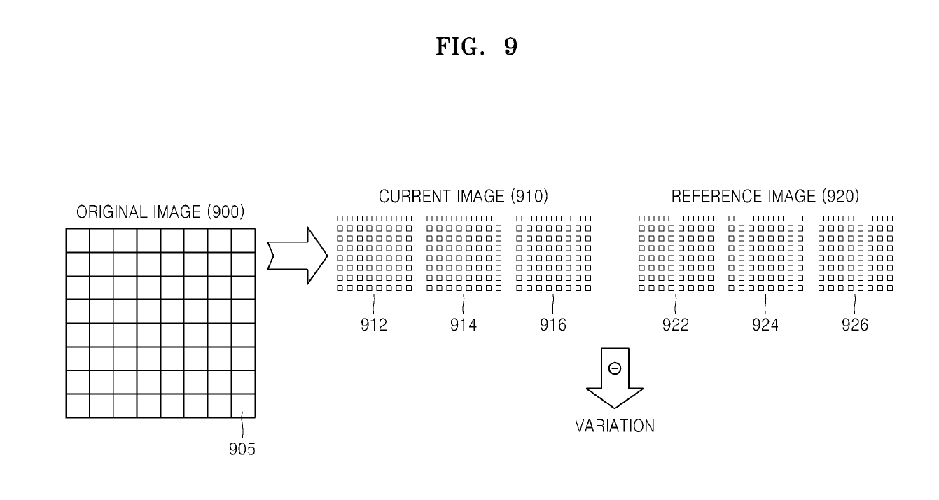

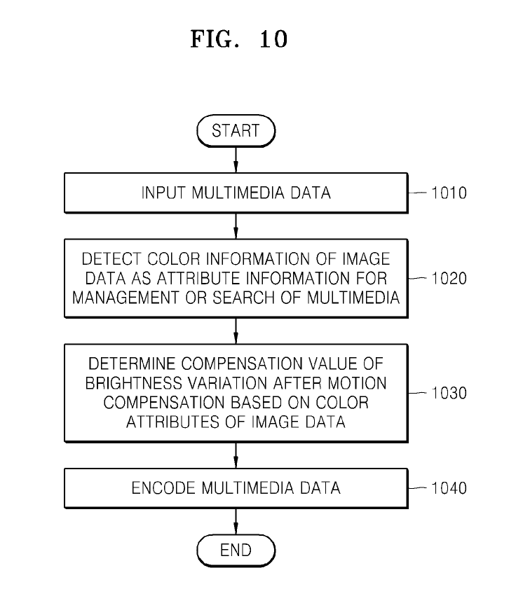

For example, the color attributes of image data can include a color layout of an image and an accumulated distribution per color bin (hereinafter, referred to as ‘color histogram’). The color attributes of image data will be described later with reference to FIGS. 8 and 9. For example, the texture attributes of image data can include homogeneity, smoothness, regularity, edge orientation, and coarseness of image texture. The texture attributes of image data will be described later with reference to FIGS. 16, 17, 18, 24, 25, and 26.

For example, the speed attributes of sound data can include tempo information of sound. The speed attributes of sound data will be described later with reference to FIG. 33.

The encoding scheme determiner 130 can determine an encoding scheme based on attributes of the multimedia by using the attribute information detected by the attribute information detector 120. The encoding scheme determined according to the attribute information may be an encoding scheme for one of a plurality of tasks of an encoding process. For example, the encoding scheme determiner 130 can determine a compensation value of a brightness variation according to the color attributes of image data. The encoding scheme determiner 130 can determine the size of a data processing unit and an estimation mode used in inter prediction according to the texture attributes of image data. In addition, a type and a direction of a predictable intra prediction mode can be determined according to the texture attributes of image data. The encoding scheme determiner 130 can determine a length of a data processing unit for frequency transform according to the speed attributes of sound data.

The encoding scheme determiner 130 can measure a variation between a pixel value of current image data and a pixel value of reference image data, i.e., a brightness variation, based on the color attributes of image data.

The encoding scheme determiner 130 can determine the size of a data processing unit for motion estimation of the current image data by using the texture attributes of image data. A data processing unit for temporal motion estimation determined by the encoding scheme determiner 130 may be a block, such as a macroblock.

The encoding scheme determiner 130 can determine the size of the data processing unit based on the homogeneity of the texture attributes so that the more homogeneous the current image data is, the more the size of the data processing unit increases. Alternatively, the encoding scheme determiner 130 can determine the size of the data processing unit based on the smoothness of the texture attributes so that the smoother the current image data is, the more the size of the data processing unit increases. Alternatively, the encoding scheme determiner 130 can determine the size of the data processing unit based on the regularity of the texture attributes so that the more regular a pattern of the current image data is, the more the size of the data processing unit increases.

The encoding scheme determiner 130 can determine a type and a direction of a predictable intra prediction mode for image data by using the texture attributes of image data. The type of the intra prediction mode can include an orientation prediction mode and a direct current (DC) mean value mode, and the direction of the intra prediction mode can include vertical, horizontal, diagonal down-left, diagonal down-right, vertical-right, horizontal-down, vertical-left, and horizontal-up directions.

The encoding scheme determiner 130 can analyze edge components of current image data by using the texture attributes of image data and determine predictable intra prediction modes from among various intra prediction modes based on the edge components. The encoding scheme determiner 130 can generate a predictable intra prediction mode table for image data by determining priorities of the predictable intra prediction modes according to a dominant edge of the image data.

The encoding scheme determiner 130 can determine a data processing unit for frequency transform of current sound data by using the speed attributes of sound data. The data processing unit for frequency transform of sound data includes a frame and a window.

The encoding scheme determiner 130 can determine the length of the data processing unit to be shorter as the current sound data is faster based on tempo information of the speed attributes of sound data.

The multimedia data encoder 140 encodes the multimedia data input to the input unit 110 based on the encoding scheme determined by the encoding scheme determiner 130. The multimedia encoding apparatus 100 can output the encoded multimedia data in the form of a bitstream.

The multimedia data encoder 140 can encode multimedia data by performing processes, such as motion estimation, motion compensation, intra prediction, frequency transform, quantization, and entropy encoding. The multimedia data encoder 140 can perform at least one of motion estimation, motion compensation, intra prediction, frequency transform, quantization, and entropy encoding by considering the attributes of multimedia content.

The multimedia data encoder 140 can encode the current image data, of which the pixel value has been compensated for, by using the variation between the pixel values determined based on the color attributes of image data. When a rapid brightness change occurs between a current image and a reference image, residuals are generated, and so a negative result is caused in encoding using temporal redundancy of an image sequence. Thus, the multimedia encoding apparatus 100 can contrive more efficient encoding by compensating for a bright variation of the reference image data and the current image data for the current image data of which motion compensation has been performed.

The multimedia data encoder 140 can perform motion estimation or motion compensation for the current image data by using the data processing unit of the inter prediction mode determined based on the texture attributes. The video encoding determines an optimal data processing unit by performing inter prediction with various data processing units for the current image data. Thus, as the number of data processing unit types increases, accuracy of the inter prediction can increase, but a burden of computation also increases.

The multimedia encoding apparatus 100 can contrive more efficient encoding by performing error rate optimization for the current image data by using a data processing unit determined based on a texture component of the current image.

The multimedia data encoder 140 can perform motion estimation for the current image data by using the intra prediction mode determined based on the texture attributes. The video encoding determines an optimal prediction direction and type of the intra prediction mode by performing intra prediction with various prediction directions and types of intra prediction modes for the current image data. Thus, as the number of intra prediction directions and the number of intra prediction mode types increase, a burden of computation increases.

The multimedia encoding apparatus 100 can contrive more efficient encoding by performing intra prediction for the current image data by using an intra prediction direction and an intra prediction mode type determined based on the texture attributes of the current image.

The multimedia data encoder 140 can perform frequency transform for the current sound data by using the data processing unit of which the length has been determined for the sound data. In audio encoding, the length of a temporal window for frequency transform determines resolution of a frequency and a change of expressible temporal sound. The multimedia encoding apparatus 100 can contrive more efficient encoding by performing frequency transform for the current sound data by using the window length determined based on the speed attributes of a current sound.

The multimedia data encoder 140 can determine the length of the data processing unit for frequency transform of the current sound data as a fixed length when valid information is not extracted as the speed attributes of sound data. Since a constant speed attribute is not extracted for irregular sound, such as a natural sound, the multimedia data encoder 140 can perform frequency transform on a data processing unit of a predetermined length.

The multimedia encoding apparatus 100 can further include a multimedia content attribute descriptor encoder (not shown) for encoding attribute information for management or search of multimedia into a descriptor for management or search of multimedia based on multimedia content (hereinafter, refer to as ‘multimedia content attribute descriptor’).

The multimedia content attribute descriptor encoder can encode at least one of metadata regarding a color layout, metadata regarding a color structure, and metadata regarding a scalable color to indicate the color attributes of image data.

The multimedia content attribute descriptor encoder can encode at least one of metadata regarding an edge histogram, metadata for texture browsing, and metadata regarding homogeneity of texture to indicate the texture attributes of image data.

The multimedia content attribute descriptor encoder can encode at least one of metadata regarding audio tempo, semantic description information, and side information to indicate the speed attributes of sound data.

The multimedia content attribute descriptor can be included together with a bitstream into which encoded multimedia data is inserted, or a bitstream without encoded multimedia data may be generated.

The multimedia encoding apparatus 100 can contrive effective encoding of multimedia data based on the attributes of multimedia content.

Information regarding the attributes of multimedia content can be separately provided in the form of a descriptor for efficient encoding/decoding of multimedia or management and search of multimedia content. In particular, in this case, the multimedia encoding apparatus 100 can extract content attributes by using a descriptor for management or search of information based on the attributes of multimedia content. Thus, effective encoding of multimedia data using the attributes of multimedia content can be performed by the multimedia encoding apparatus 100 without additional analysis of content attributes.

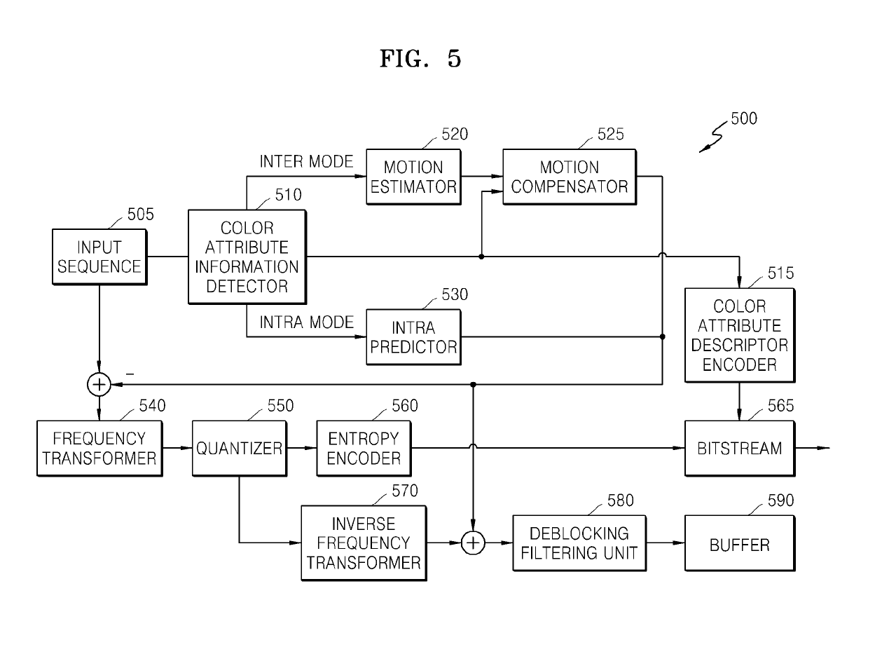

For the multimedia encoding apparatus 100, various embodiments exist according to content attributes and a determined encoding scheme. A case where a brightness variation compensation value is determined according to the color attributes of image data from among the various embodiments of the multimedia encoding apparatus 100 will be described later with reference to FIG. 5.

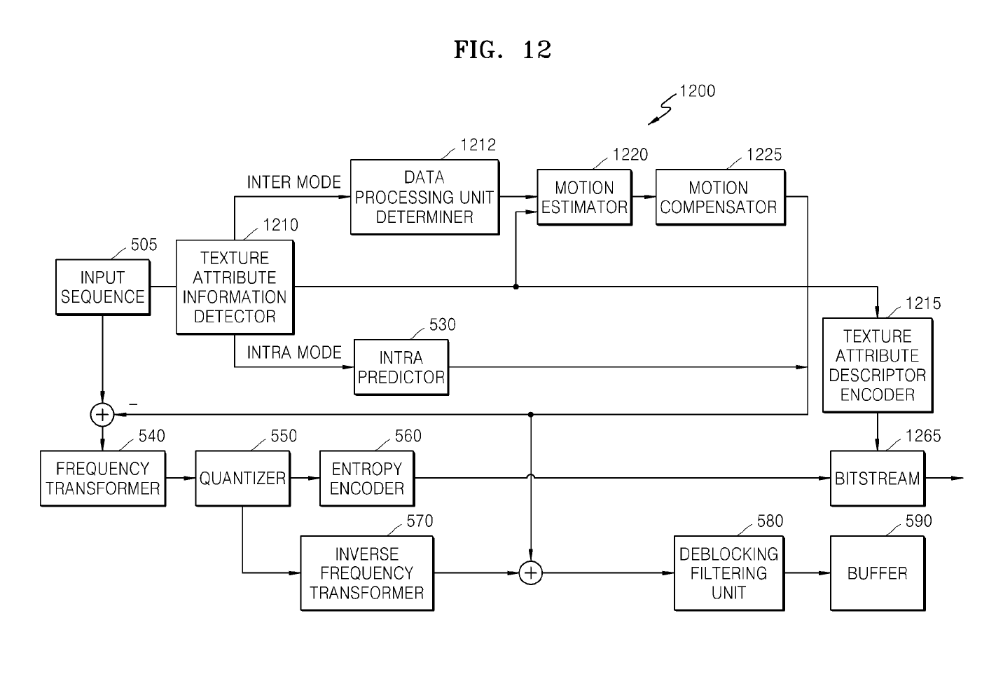

A case where a data processing unit for inter prediction is determined according to the texture attributes of image data from among the various embodiments of the multimedia encoding apparatus 100 will be described later with reference to FIG. 12.

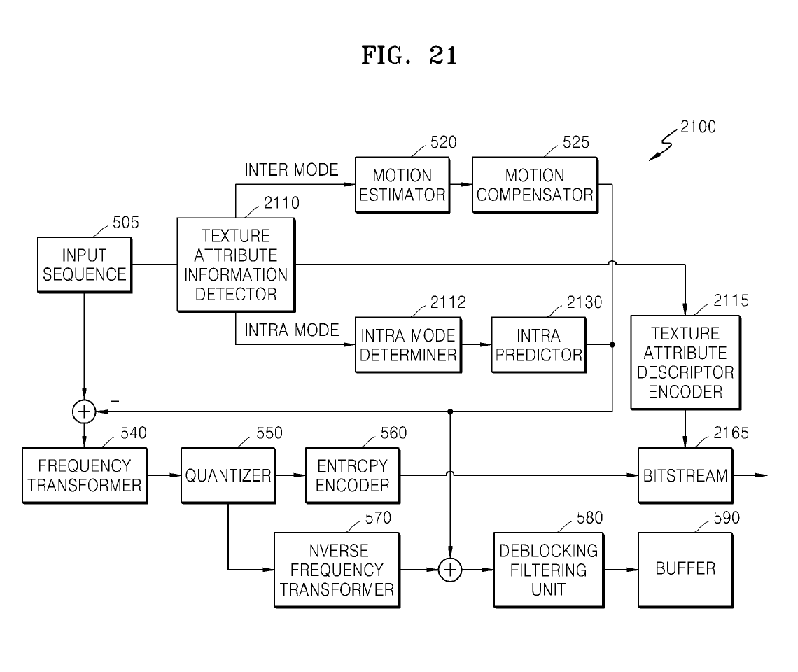

A case where a type and a direction of an intra prediction mode is determined according to the texture attributes of image data from among the various embodiments of the multimedia encoding apparatus 100 will be described later with reference to FIG. 21.

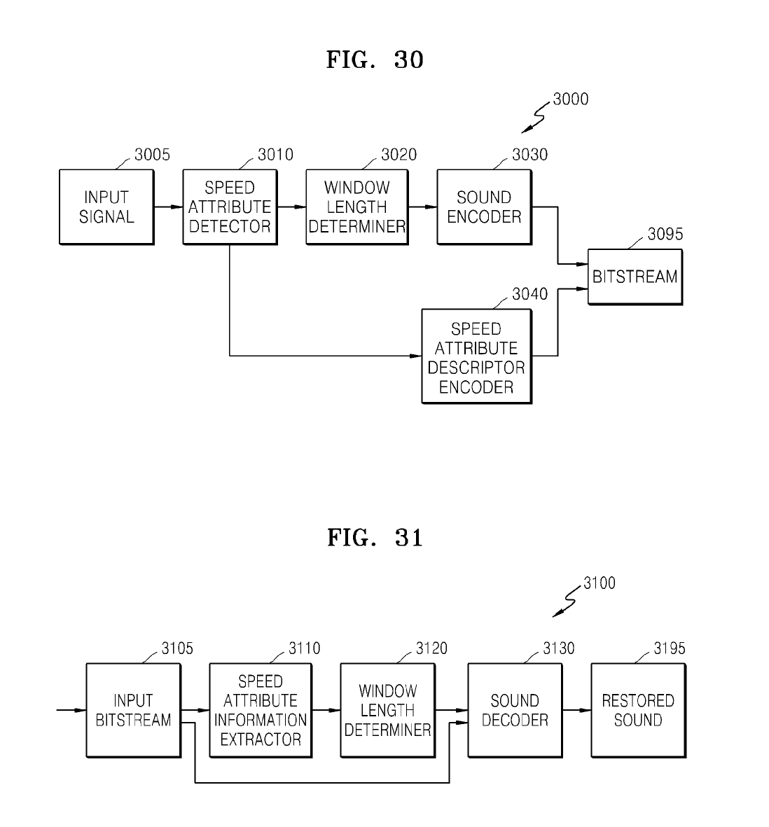

A case where a length of a data processing unit for frequency transform is determined according to the speed attributes of sound data from among the various embodiments of the multimedia encoding apparatus 100 will be described later with reference to FIG. 30.

FIG. 2 is a block diagram of a multimedia decoding apparatus 200, according to an exemplary embodiment.

Referring to FIG. 2, the multimedia decoding apparatus 200 includes a receiver 210, an attribute information extractor 220, a decoding scheme determiner 230, and a multimedia data decoder 240.

The receiver 210 classifies encoded multimedia data and information regarding the multimedia by receiving a bitstream of multimedia data and parsing the bitstream. The multimedia can include every type of data such as an image and sound. The information regarding the multimedia can include metadata and a content attribute descriptor.

The attribute information extractor 220 extracts attribute information for management or search of the multimedia from the information regarding the multimedia received from the receiver 210. The attribute information can be information based on attributes of multimedia content.

For example, color attributes of image data among the attributes of multimedia content can include a color layout of an image and a color histogram. Texture attributes of image data among the attributes of multimedia content can include homogeneity, smoothness, regularity, edge orientation, and coarseness of image texture. Speed attributes of sound data among the attributes of multimedia content can include tempo information of sound.

The attribute information extractor 220 can extract attribute information of multimedia content from a descriptor for management or search of multimedia information based on the attributes of multimedia content.

For example, the attribute information extractor 220 can extract color attribute information of image data from at least one of a color layout descriptor, a color structure descriptor, and a scalable color descriptor. The attribute information extractor 220 can extract texture attribute information of image data from at least one of an edge histogram descriptor, a texture browsing descriptor, and a homogeneous texture descriptor. The attribute information extractor 220 can extract speed attribute information of sound data from at least one of an audio tempo descriptor, semantic description information, and side information.

The decoding scheme determiner 230 determines a decoding scheme based on attributes of the multimedia by using the attribute information extracted by the attribute information extractor 220.

The decoding scheme determiner 230 can measure a variation between a pixel value of current image data and a pixel value of reference image data, i.e., a brightness variation, based on the color attributes of image data.

The decoding scheme determiner 230 can determine the size of a data processing unit for motion estimation of current image data by using the texture attributes of image data. A data processing unit for motion estimation of inter prediction can be a block, such as a macroblock.

The decoding scheme determiner 230 can determine the size of the data processing unit for inter prediction of the current image data so that the more one of homogeneity, smoothness, and regularity of the texture attributes of the current image data increases, the more the size of the data processing unit for inter prediction of the current image data increases.

The decoding scheme determiner 230 can analyze edge components of the current image data by using the texture attributes of image data and determine predictable intra prediction modes from among various intra prediction modes based on the edge components. The decoding scheme determiner 230 can generate a predictable intra prediction mode table for image data by determining priorities of the predictable intra prediction modes according to a dominant edge of the image data.

The decoding scheme determiner 230 can determine a data processing unit for frequency transform of current sound data by using the speed attributes of sound data. The data processing unit for frequency transform of sound data includes a frame and a window. The decoding scheme determiner 230 can determine the length of the data processing unit to be shorter as the current sound data becomes faster, based on tempo information of the speed attributes of sound data.

The multimedia data decoder 240 decodes the encoded data of the multimedia, which has been inputted from the receiver 210, according to the decoding scheme, based on the attributes of the multimedia, which has been determined by the decoding scheme determiner 230.

The multimedia data decoder 240 can decode multimedia data by performing processes, such as motion estimation, motion compensation, intra prediction, inverse frequency transform, dequantization, and entropy decoding. The multimedia data decoder 240 can perform at least one of motion estimation, motion compensation, intra prediction, inverse frequency transform, dequantization, and entropy decoding by considering the attributes of multimedia content.

The multimedia data decoder 240 can perform motion compensation for inverse-frequency-transformed current image data and compensate for the pixel value of the current image data by using a variation between the pixel values determined based on the color attributes of image data.

The multimedia data decoder 240 can perform motion estimation or motion compensation for the current image data according to the inter prediction mode in which the size of the data processing unit is determined based on the texture attributes.

The multimedia data decoder 240 can perform intra prediction for the current image data according to the intra prediction mode in which an intra prediction direction and a type of the intra prediction mode are determined based on the texture attributes.

The multimedia data decoder 240 can perform inverse frequency transform for the current sound data according to determination of the length of the data processing unit for frequency transform based on the speed attributes of sound data.

The multimedia data decoder 240 can perform inverse frequency transform by determining the length of the data processing unit for inverse frequency transform of the current sound data as a fixed length when valid information is not extracted as the speed attributes of sound data.

The multimedia decoding apparatus 200 can further include a restorer (not shown) for restoring the decoded multimedia data.

The multimedia decoding apparatus 200 can extract the attributes of multimedia content by using a descriptor provided for management and search of multimedia information in order to perform decoding by taking the attributes of multimedia content into account. Thus, the multimedia decoding apparatus 200 can efficiently decode multimedia even without an additional process for directly analyzing the attributes of multimedia content or new additional information.

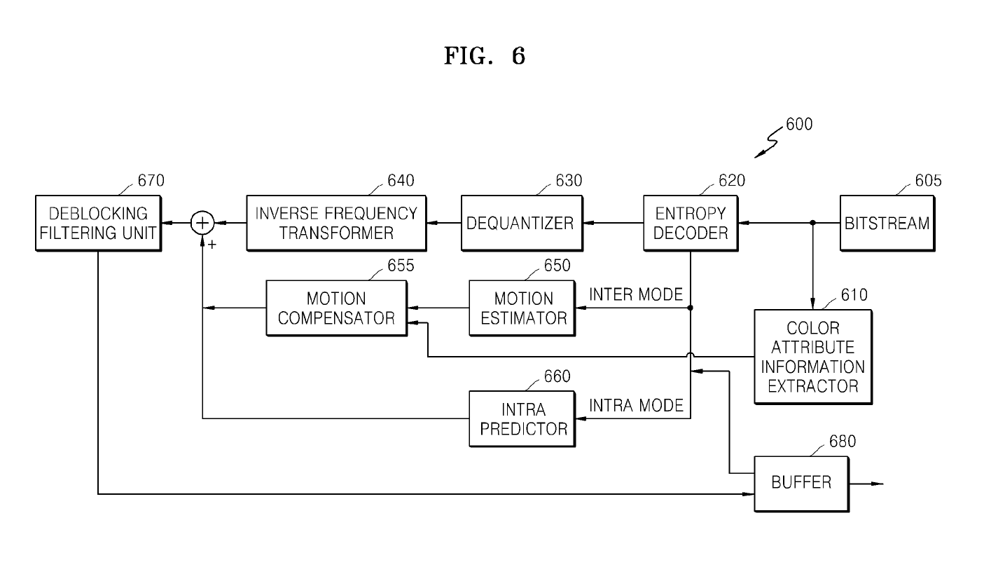

For the multimedia decoding apparatus 200, various exemplary embodiments exist according to content attributes and a determined decoding scheme. A case where a brightness variation compensation value is determined according to the color attributes of image data from among the various embodiments of the multimedia decoding apparatus 200 will be described later with reference to FIG. 6.

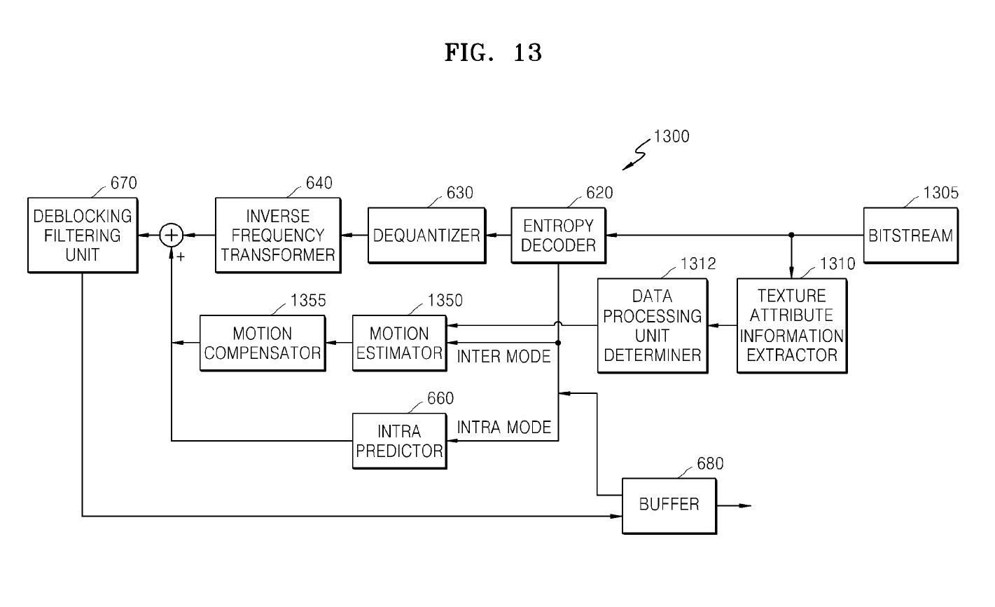

A case where a data processing unit for inter prediction is determined according to the texture attributes of image data from among the various embodiments of the multimedia decoding apparatus 200 will be described later with reference to FIG. 13.

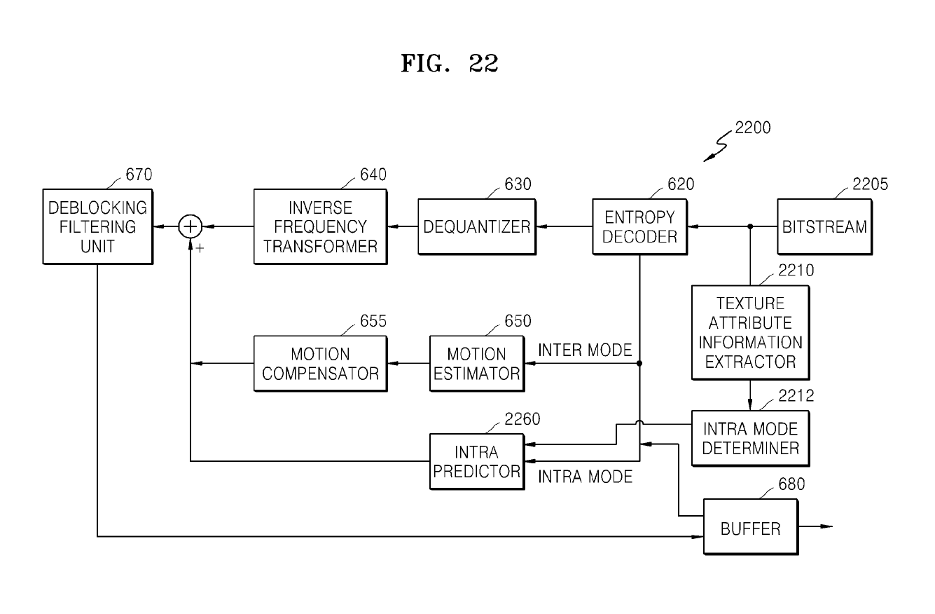

A case where a type and a direction of an intra prediction mode is determined according to the texture attributes of image data from among the various embodiments of the multimedia decoding apparatus 200 will be described later with reference to FIG. 22.

A case where a length of a data processing unit for inverse frequency transform is determined according to the speed attributes of sound data from among the various embodiments of the multimedia decoding apparatus 200 will be described later with reference to FIG. 31.

The multimedia encoding apparatus 100 and the multimedia decoding apparatus 200 according to exemplary embodiments, which have been described above with reference to FIGS. 1 and 2, are applicable to every video encoding/decoding device based on spatial prediction or temporal prediction or every image processing method and apparatus using the video encoding/decoding device.

For example, a process of the multimedia encoding apparatus 100 and the multimedia decoding apparatus 200 can be applied to mobile communication devices, such as a cellular phone, image capturing devices, such as a camcorder and a digital camera, multimedia reproducing devices, such as a multimedia player, a Portable Multimedia Player (PMP), and a next generation Digital Versatile Disc (DVD), and software video codecs.

In addition, the multimedia encoding apparatus 100 and the multimedia decoding apparatus 200 can be applied not only current image compression standards such as MPEG-7 and H.26X, but also next generation image compression standards.

The process of the multimedia encoding apparatus 100 and the multimedia decoding apparatus 200 can be applied to media applications providing not only an image compression function but also a search function used simultaneously with or independently from image compression.

Metadata includes information effectively presenting content, and the information included in the metadata includes some information useful for encoding or decoding of multimedia data. Thus, although syntax information of the metadata is provided for an information search, an increase of encoding or decoding efficiency of sound data can be contrived by using strong connection between the syntax information and sound data.

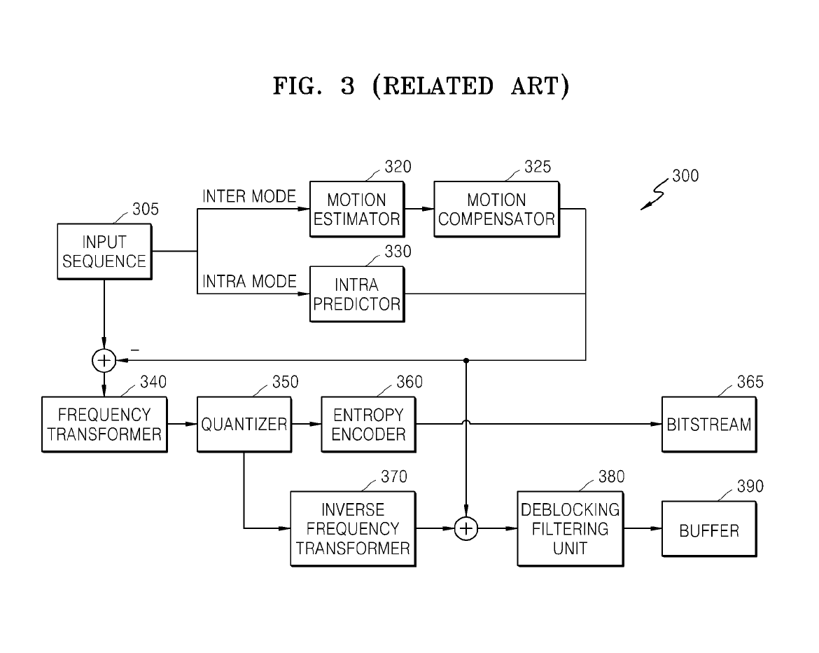

FIG. 3 is a block diagram of a typical video encoding apparatus 300.

Referring to FIG. 3, the conventional video encoding apparatus 300 can include a frequency transformer 340, a quantizer 350, an entropy encoder 360, a motion estimator 320, a motion compensator 325, an intra predictor 330, an inverse frequency transformer 370, a deblocking filtering unit 380, and a buffer 390.

The frequency transformer 340 transforms residuals of a predetermined image and a reference image of an input sequence 305 to data in a frequency domain, and the quantizer 350 approximates the data transformed in the frequency domain to a finite number of values. The entropy encoder 360 encodes the quantized values without any loss, thereby outputting a bitstream 365 obtained by encoding the input sequence 305.

To use temporal redundancy between different images of the input sequence 305, the motion estimator 320 estimates a motion between the different images, and the motion compensator 325 compensates for a motion of a current image by considering a motion estimated relatively to a reference image.

In addition, to use spatial redundancy of different areas of an image of the input sequence 305, the intra predictor 330 predicts a reference area most similar to a current area of the current image.

Thus, the reference image for obtaining a residual of the current image can be an image of which a motion has been compensated for by the motion compensator 325, based on the temporal redundancy. Alternatively, the reference image can be an image predicted in an intra prediction mode by the intra predictor 330, based on the spatial redundancy in the same image.

The deblocking filtering unit 380 reduces a blocking artifact generated in a boundary of data processing units of frequency transform, quantization, and motion estimation for image data, which has been transformed to data in a spatial domain by the inverse frequency transformer 370 and added to the reference image data. A deblocking-filtered decoded picture can be stored in the buffer 390.

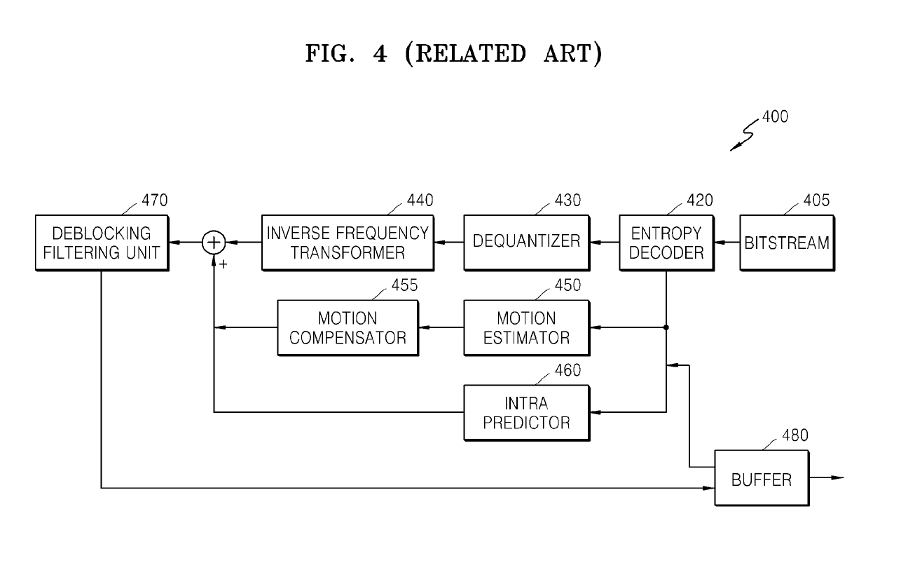

FIG. 4 is a block diagram of a conventional video decoding apparatus 400.

Referring to FIG. 4, the conventional video decoding apparatus 400 includes an entropy decoder 420, a dequantizer 430, an inverse frequency transformer 440, a motion estimator 450, a motion compensator 455, an intra predictor 460, a deblocking filtering unit 470, and a buffer 480.

An input bitstream 405 is lossless-decoded and dequantized by the entropy decoder 420 and the dequantizer 430, and the inverse frequency transformer 440 outputs data in the spatial domain by performing an inverse frequency transform on the dequantized data.

The motion estimator 450 and the motion compensator 455 compensate for a temporal motion between different images by using a deblocked reference image and a motion vector, and the intra predictor 460 performs intra prediction by using the deblocked reference image and a reference index.

Current image data is generated by adding a motion-compensated or intra-predicted reference image to an inverse-frequency-transformed residual. The current image data passes by the deblocking filtering unit 470, thereby reducing a blocking artifact generated in a boundary of data processing units of inverse frequency transform, dequantization, and motion estimation. A decoded and deblocking-filtered picture can be stored in the buffer 480.

Although the conventional video encoding apparatus 300 and the conventional video decoding apparatus 400 use the temporal redundancy between consecutive images and the spatial redundancy between neighboring areas in the same image in order to reduce an amount of data for expressing an image, the conventional video encoding apparatus 300 and the conventional video decoding apparatus 400 do not take attributes of the image into account in any regard.

An exemplary embodiment for encoding or decoding image data based on the color attributes of the content attributes will be described with reference to FIGS. 5 to 11.

An exemplary embodiment for encoding or decoding image data based on the texture attributes of the content attributes will be described with reference to FIGS. 12 to 20.

An exemplary embodiment for encoding or decoding image data based on the texture attributes of the content attributes will be described with reference to FIGS. 21 to 29.

An exemplary embodiment for encoding or decoding sound data based on the speed attributes of the content attributes will be described with reference to FIGS. 30 to 35.

The exemplary embodiment for encoding or decoding image data based on the color attributes of the content attributes will now be described with reference to FIGS. 5 to 11.

FIG. 5 is a block diagram of a multimedia encoding apparatus 500 based on the color attributes of multimedia, according to the embodiment of the present invention.

Referring to FIG. 5, the multimedia encoding apparatus 500 includes a color attribute information detector 510, a motion estimator 520, a motion compensator 525, an intra predictor 530, a frequency transformer 540, a quantizer 550, an entropy encoder 560, an inverse frequency transformer 570, a deblocking filtering unit 580, a buffer 590, and a color attribute descriptor encoder 515.

The multimedia encoding apparatus 500 generates a bitstream 565 encoded by omitting redundant data by using the temporal redundancy of consecutive images and the spatial redundancy in the same image of an input sequence 505.

That is, inter prediction and motion compensation are performed by the motion estimator 520 and the motion compensator 525, intra prediction is performed by the intra predictor 530, and the encoded bitstream 565 is generated by the frequency transformer 540, the quantizer 550, and the entropy encoder 560. A blocking artifact, which may be generated in an encoding process, can be removed by the inverse frequency transformer 570 and the deblocking filtering unit 580.

Compared with the conventional video encoding apparatus 300, the multimedia encoding apparatus 500 further includes the color attribute information detector 510 and the color attribute descriptor encoder 515. In addition, an operation of the motion compensator 525 using color attribute information detected by the color attribute information detector 510 is different from that of the motion compensator 325 of the conventional video encoding apparatus 300.

The color attribute information detector 510 according to an exemplary embodiment extracts a color histogram or a color layout by analyzing the input sequence 505. For example, according to a YCbCr color standard, the color layout includes discrete-cosine-transformed coefficient values for Y, Cb, and Cr color components per sub image.

The color attribute information detector 510 can measure a brightness variation between a current image and a reference image by using a color histogram or a color layout of each of the current image and the reference image. The current image and the reference image can be consecutive images.

The motion compensator 525 can compensate for a rapid brightness change by adding the brightness variation to an area predicted after motion compensation. For example, the brightness variation measured by the color attribute information detector 510 can be added to a mean value of pixels in the predicted area.

Since the rapid brightness change increases a residual, efficiency of image data encoding may decrease. Thus, efficient encoding can be contrived by performing motion compensation after measuring a variation between pixel values of consecutive image data by using the color attributes and compensating for a pixel value of current image data by using a variation between a pixel value of previous image data and a pixel value of the current image data.

When the color attribute detected by the color attribute information detector 510 is a color layout, the color attribute descriptor encoder 515 according to an exemplary embodiment can encode the attribute information to metadata regarding the color layout by using color layout information. For example, an example of the metadata regarding the color layout in an environment based on an MPEG-7 compression standard can be a color layout descriptor.

Alternatively, when the color attribute detected by the color attribute information detector 510 is a histogram, the color attribute descriptor encoder 515 can encode the attribute information to metadata regarding a color structure or metadata regarding a scalable color by using color histogram information.

For example, an example of the metadata regarding the color structure in an environment based on the MPEG-7 compression standard can be a color structure descriptor. In another example, an example of the metadata regarding the scalable color in an environment based on the MPEG-7 compression standard can be a scalable color descriptor.

Each of the metadata regarding a color layout, the metadata regarding a color structure, and the metadata regarding a scalable color correspond to a descriptor for management and search of information regarding multimedia content.

The color layout descriptor is a descriptor schematically representing the color attributes. Color components of Y, Cb, and Cr are generated by transforming an input image to an image in a YCbCr color space, dividing the YCbCr image into small areas of an 8×8 pixel size, and calculating a mean value of pixel values of each area. The color attribute can be extracted by performing an 8×8 discrete cosine transform for each of the generated color components of Y, Cb, and Cr in the small areas and selecting the number of transformed coefficients.

The color structure descriptor is a descriptor representing a spatial distribution of color bin values of an image. A local histogram is extracted by using a window mask of an 8×8 size based on a Common Interchange Format (CIF)-sized image (352 pixels in horizontal and 288 pixels in vertical). When color bin values of a local histogram exist, corresponding color bins of a last histogram are updated, and therefore, an accumulated spatial distribution of color components corresponding to every color bin can be analyzed.

The scalable color descriptor is a color descriptor that is a modified form of a color histogram descriptor and is represented by having scalability through a Haar transform of a color histogram.

The color attribute descriptor encoded by the color attribute descriptor encoder 515 can be included in the bitstream 565 as the encoded multimedia data was. Alternatively, the color attribute descriptor encoded by the color attribute descriptor encoder 515 may be output as a bitstream different from that in which the encoded multimedia data is included.

Compared with the multimedia encoding apparatus 100 according to an exemplary embodiment, the input sequence 505 can correspond to the image input through the input unit 110, and the color attribute information detector 510 can correspond to the attribute information detector 120 and the encoding scheme determiner 130. The motion estimator 520, the motion compensator 525, the intra predictor 530, the frequency transformer 540, the quantizer 550, the entropy encoder 560, the inverse frequency transformer 570, the deblocking filtering unit 580, and the buffer 590 can correspond to the multimedia data encoder 140.

The motion compensator 525 can prevent an increase of a residual due to a rapid brightness change or an increase of the number of intra prediction counts by adding a brightness variation compensation value measured by the color attribute information detector 510 to a motion-compensated image after the motion compensation.

Another exemplary embodiment of the color attribute information detector 510 may determine whether to perform inter prediction or intra prediction according to a level of a brightness change between two images by using extracted color attributes of a reference image and a current image. For example, it can be determined that intra prediction is performed if a brightness change between the reference image and the current image is less than a predetermined threshold and inter prediction is performed if the brightness change between the reference image and the current image is equal to or greater than the predetermined threshold.

FIG. 6 is a block diagram of a multimedia decoding apparatus 600, according to an exemplary embodiment.

Referring to FIG. 6, the multimedia decoding apparatus 600 includes a color attribute information extractor 610, an entropy decoder 620, a dequantizer 630, an inverse frequency transformer 640, a motion estimator 650, a motion compensator 655, an intra predictor 660, a deblocking filtering unit 670, and a buffer 680.

An entire decoding process of the multimedia decoding apparatus 600 is to generate a restored image by using encoded multimedia data of an input bitstream 605 and all pieces of information of the multimedia data.

That is, the bitstream 605 is lossless-decoded by the entropy decoder 620, and a residual in a spatial area is decoded by the dequantizer 630 and the inverse frequency transformer 640. The motion estimator 650 and the motion compensator 655 can perform temporal motion estimation and motion compensation by using a reference image and a motion vector, and the intra predictor 660 can perform intra prediction by using the reference image and index information.

An image obtained by adding the residual to the reference image passes through the deblocking filtering unit 670, thereby reducing a blocking artifact, which may be generated during a decoding process. A decoded picture can be stored in the buffer 680.

Compared with the conventional video decoding apparatus 400, the multimedia decoding apparatus 600 further includes the color attribute information extractor 610. In addition, an operation of the motion compensator 655 using color attribute information extracted by the color attribute information extractor 610 is different from that of the motion compensator 455 of the conventional video decoding apparatus 400.

The color attribute information extractor 610 according to the exemplary embodiment can extract color attribute information by using a color attribute descriptor classified from the input bitstream 605. For example, if the color attribute descriptor is any one of metadata regarding a color layout, metadata regarding a color structure, and metadata regarding a scalable color, a color layout or a color histogram can be extracted.

For example, in an environment based on the MPEG-7 compression standard, the metadata regarding a color layout, the metadata regarding a color structure, and the metadata regarding a scalable color can be a color layout descriptor, a color structure descriptor, and a scalable color descriptor, respectively.

The color attribute information extractor 610 can measure a brightness variation between a reference image and a current image from color attributes of the reference image and the current image. The motion compensator 655 can compensate for a rapid brightness change by adding the brightness variation to an area predicted after motion compensation. For example, the brightness variation measured by the color attribute information extractor 610 can be added to a mean value of pixels in the predicted area.

Compared with the multimedia decoding apparatus 200 according to an exemplary embodiment, the input bitstream 605 can correspond to the bitstream input through the receiver 210, and the color attribute information extractor 610 can correspond to the attribute information extractor 220 and the decoding scheme determiner 230. The motion estimator 650, the motion compensator 655, the intra predictor 660, the inverse frequency transformer 640, the dequantizer 630, the entropy decoder 620, the deblocking filtering unit 670, and the buffer 680 can correspond to the multimedia data decoder 240.

Since encoding efficiency may decrease due to a rapid brightness change, when a bitstream encoded with a brightness change compensated in an encoding end is decoded, an original image can be restored only if a brightness variation is compensated in a reverse way for image data decoded after motion compensation.

Another exemplary embodiment of the color attribute information extractor 610 may determine whether to perform inter prediction or intra prediction according to a level of a brightness change between two images by using extracted color attributes of a reference image and a current image. For example, it can be determined that intra prediction is performed if a brightness change between the reference image and the current image is less than a predetermined threshold and inter prediction is performed if the brightness change between the reference image and the current image is equal to or greater than the predetermined threshold.

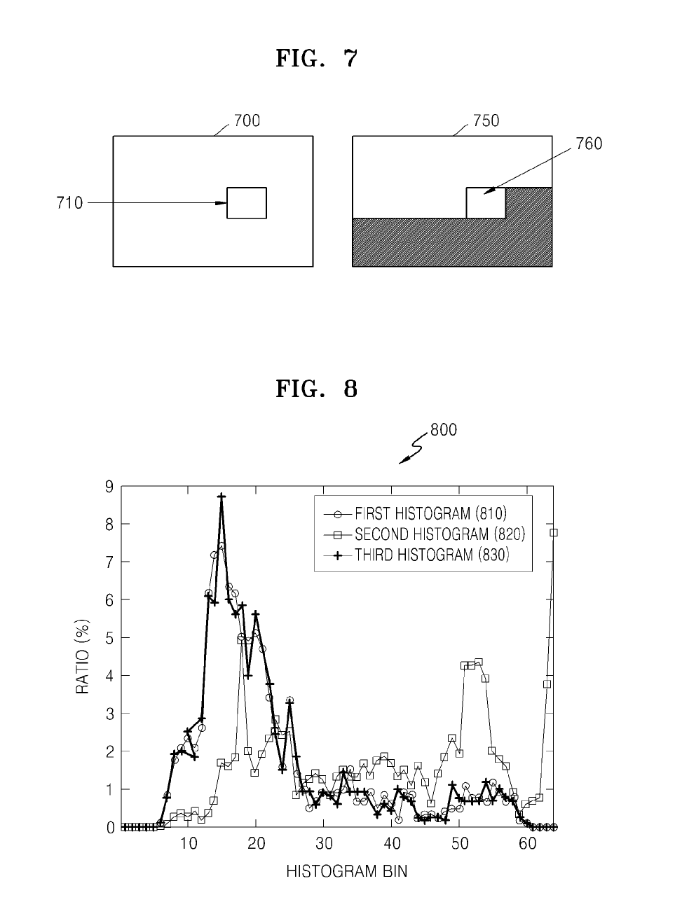

FIG. 7 illustrates a brightness change between consecutive frames, which is measured using color attributes, according to the exemplary embodiment.

When a rapid brightness change, such as flashlight, is generated, a DC value change occurs between an original image and a prediction image. In addition, since a rapid DC value change causes intra prediction instead of inter prediction, it is not preferable in terms of encoding efficiency.

When a brightness variation of a current area 760 of a current image 750 is calculated by using a reference area 710 of a reference image 700, a color layout descriptor (CLD) can be used. The CLD represents a frequency-transformed value of a representative value of each of Y, Cr, Cb color components for every 64 sub images of an image. Thus, Equation 1 can be derived by using a variation ±Δ_{CLD} between an inverse-frequency-transformed value of a CLD of the reference area 710 and an inverse-frequency-transformed value of a CLD of the current area 760.

±Δ_{CLD}=(mean pixel value of reference area)−(mean pixel value of current area) (Equation 1)

±Δ_{CLD} can correspond to a brightness variation between the reference area 710 and the current area 760. Accordingly, the color attribute information detector 510 or the color attribute information extractor 610 can measure the variation ±Δ_{CLD} between the inverse-frequency-transformed value of the CLD of the reference area 710 and the inverse-frequency-transformed value of the CLD of the current area 760, thereby compensating for ±Δ_{CLD} as a brightness variation to a motion-compensated current area.

FIG. 8 illustrates a color histogram used as color attributes, according to an exemplary embodiment.

A histogram bin (horizontal axis) of a color histogram 800 indicates the intensity per color. A first histogram 810, a second histogram 820, and a third histogram 830 are color histograms for a first image, a second image, and a third image, which are three consecutive images, respectively.

The first histogram 810 and the third histogram 830 show almost similar intensity and distribution, whereas the second histogram 820 has an overwhelmingly high accumulated distribution for the rightmost histogram bin in comparison with the first histogram 810 and the third histogram 830.

The first histogram 810, the second histogram 820, and the third histogram 830 can be shown when the first image is captured under typical lighting, a rapid brightness change occurs due to illumination of a flashlight (the second image), and the third image is captured under the typical lighting without the flashlight.

Accordingly, images in which a rapid brightness change has occurred can be detected by analyzing differences between the first, second, and third color histograms 810, 820, and 830, thereby grasping image levels.

FIG. 9 illustrates a color layout used as color attributes, according to an exemplary embodiment.

The color layout is generated by dividing an original image 900 into 64 sub images, such as a sub image 905, and calculating a mean value per color component for each sub image. A binary code generated by performing an 8×8 discrete cosine transform for each of a Y component, a Cb component, and a Cr component of the sub image 905 and weighing transformed coefficients according to a zigzag scanning sequence is a CLD. The CLD can be transmitted to a decoding end and can be used for sketch-based retrieval.

A color layout of a current image 910 includes Y component mean values 912, Cr component mean values 914, and Cb component mean values 916 of sub images of the current image 910. A color layout of a reference image 920 includes Y component mean values 922, Cr component mean values 924, and Cb component mean values 926 of sub images of the reference image 920.

In the exemplary embodiment, a difference value between the color layout of the current image 910 and the color layout of the reference image 920 can be used as a brightness variation between the current image 910 and the reference image 920 as ±Δ_{CLD} of Equation 1. Thus, the motion compensator 525 or the motion compensator 655 according to the embodiment of the present invention can compensate for a brightness change by adding the difference value between the color layout of the current image 910 and the color layout of the reference image 920 to a motion-compensated current prediction image.

FIG. 10 is a flowchart of a multimedia encoding method, according to an exemplary embodiment.

Referring to FIG. 10, multimedia data is input in operation 1010.

In operation 1020, color information of image data is detected as attribute information for management or search of multimedia. The color information can be a color histogram and a color layout.

In operation 1030, a compensation value of a brightness variation after motion compensation can be determined based on color attributes of the image data. The compensation value of the brightness variation can be determined by using a difference between color histograms or color layouts of a current image and a reference image. Rapidly changed brightness of the current image can be compensated for by adding the compensation value of the brightness variation to a motion-compensated current image.

In operation 1040, the multimedia data can be encoded. The multimedia data can be output in the form of a bitstream by being encoded through frequency transform, quantization, deblocking filtering, and entropy encoding.

The color attributes extracted in operation 1010 can be encoded to metadata regarding a color layout, metadata regarding a color structure, and metadata regarding a scalable color and used for management or search of multimedia information based on attributes of multimedia content in a decoding end. A descriptor can be output in the form of a bitstream together with the encoded multimedia data.

A Peak Signal to Noise Ratio (PSNR) of a predicted block can be enhanced and coefficients of a residual can be reduced by the multimedia encoding apparatus 100, thereby increasing encoding efficiency. Of course, as described above, multimedia information can be searched for by using the descriptor.

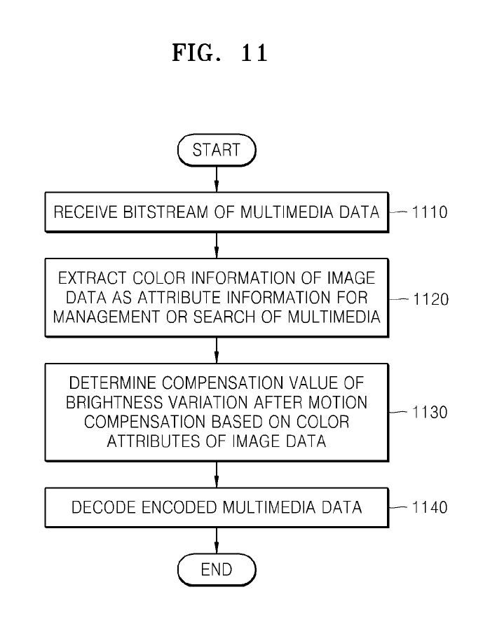

FIG. 11 is a flowchart of a multimedia decoding method, according to the embodiment of the present invention.

Referring to FIG. 11, a bitstream of multimedia data is received in operation 1110. The bitstream can be parsed and classified into encoded multimedia data and information data regarding the multimedia.

In operation 1120, color information of image data can be extracted as attribute information for management or search of multimedia. The attribute information for management or search of multimedia can be extracted from a descriptor for management and search of multimedia information based on the attributes of multimedia content.

In operation 1130, a compensation value of a brightness variation after motion compensation can be determined based on color attributes of the image data. A difference between a color component mean value of a current area and a color component mean value of a reference area can be used as the compensation value of the brightness variation by using a color histogram and a color layout of the color attributes.

In operation 1140, the encoded multimedia data can be decoded. The encoded multimedia data can be restored to multimedia data by being decoded through entropy decoding, dequantization, inverse frequency transform, motion estimation, motion compensation, intra prediction, and deblocking filtering.

The exemplary embodiment for encoding or decoding image data based on the texture attributes of the content attributes will now be described with reference to FIGS. 12 to 20.

FIG. 12 is a block diagram of a multimedia encoding apparatus 1200, according to an exemplary embodiment.

Referring to FIG. 12, the multimedia encoding apparatus 1200 includes a texture attribute information detector 1210, a data processing unit determiner 1212, a motion estimator 1220, a motion compensator 1225, the intra predictor 530, the frequency transformer 540, the quantizer 550, the entropy encoder 560, the inverse frequency transformer 570, the deblocking filtering unit 580, the buffer 590, and a texture attribute descriptor encoder 1215.

The multimedia encoding apparatus 1200 generates a bitstream 1265 encoded by omitting redundant data by using the temporal redundancy of consecutive images and the spatial redundancy in the same image of the input sequence 505.

Compared with the conventional video encoding apparatus 300, the multimedia encoding apparatus 1200 further includes the texture attribute information detector 1210, the data processing unit determiner 1212, and the texture attribute descriptor encoder 1215. In addition, operations of the motion estimator 1220 and the motion compensator 1225 using a data processing unit determined by the data processing unit determiner 1212 are different from those of the motion estimator 320 and the motion compensator 325 of the conventional video encoding apparatus 300.

The texture attribute information detector 1210 according to the exemplary embodiment extracts texture components by analyzing the input sequence 505. For example, the texture components can be homogeneity, smoothness, regularity, edge orientation, and coarseness.

The data processing unit determiner 1212 can determine the size of a data processing unit for motion estimation of image data by using the texture attributes detected by the texture attribute information detector 1210. The data processing unit can be a rectangular type block.

For example, the data processing unit determiner 1212 can determine the size of the data processing unit by using homogeneity of texture attributes of the image data so that the more homogeneous texture of image data is, the more the size of the data processing unit increases. The data processing unit determiner 1212 may determine the size of the data processing unit by using smoothness of the texture attributes of the image data so that the smoother the image data is, the more the size of the data processing unit increases. The data processing unit determiner 1212 may determine the size of the data processing unit by using regularity of the texture attributes of the image data so that the more regular a pattern of the image data is, the more the size of the data processing unit increases.

In particular, data processing units of various sizes can be classified into a plurality of groups according to size. In one group, data processing units having sizes within a predetermined range can be included. If a predetermined group is mapped according to texture attributes of image data, the data processing unit determiner 1212 can perform rate distortion optimization (RDO) by using data processing units in the group and determine a data processing unit in which a minimum rate distortion occurs as an optimal data processing unit.

Thus, based on the texture components, it can be determined that the size of a data processing unit is small for a part in which an information change is great, and the size of a data processing unit is large for a part in which an information change is small.

The motion estimator 1220 and the motion compensator 1225 can respectively perform motion estimation and motion compensation by using the data processing unit determined by the data processing unit determiner 1212.

If the texture attribute detected by the texture attribute information detector 1210 is an edge histogram, the texture attribute descriptor encoder 1215 can encode metadata regarding the edge histogram by using edge histogram information. For example, the metadata regarding the edge histogram can be an edge histogram descriptor in an environment of the MPEG-7 compression standard.

Alternatively, if the texture attributes detected by the texture attribute information detector 1210 are edge orientation, regularity, and coarseness, the texture attribute descriptor encoder 1215 can encode metadata for texture browsing by using texture information. For example, the metadata for texture browsing can be a texture browsing descriptor in an environment of the MPEG-7 compression standard.

Alternatively, if the texture attribute detected by the texture attribute information detector 1210 is homogeneity, the texture attribute descriptor encoder 1215 can encode metadata regarding texture homogeneity by using homogeneity information. For example, the metadata regarding texture homogeneity can be a homogeneous texture descriptor in an environment of the MPEG-7 compression standard.

The metadata regarding an edge histogram, the metadata for texture browsing, and the metadata regarding texture homogeneity conespond to a descriptor for management and search of information regarding multimedia content.

The texture attribute descriptor encoded by the texture attribute descriptor encoder 1215 can be included in the bitstream 1265 as the encoded multimedia data was. Alternatively, the texture attribute descriptor encoded by the texture attribute descriptor encoder 1215 may be output as a bitstream different from that in which the encoded multimedia data is included.

Compared with the multimedia encoding apparatus 100, the input sequence 505 can conespond to the image input through the input unit 110, the texture attribute information detector 1210 can correspond to the attribute information detector 120, and the data processing unit determiner 1212 can correspond to the encoding scheme determiner 130. The motion estimator 1220, the motion compensator 1225, the intra predictor 530, the frequency transformer 540, the quantizer 550, the entropy encoder 560, the inverse frequency transformer 570, the deblocking filtering unit 580, and the buffer 590 can correspond to the multimedia data encoder 140.

Since motion estimation or motion compensation for a current image is achieved by using a data processing unit predetermined based on the texture attributes without the necessity of a try of the RDO for all types of data processing units, an amount of computations for encoding can be reduced.

FIG. 13 is a block diagram of a multimedia decoding apparatus 1300, according to an exemplary embodiment.

Referring to FIG. 13, the multimedia decoding apparatus 1300 includes a texture attribute information extractor 1310, a data processing unit determiner 1312, the entropy decoder 620, the dequantizer 630, the inverse frequency transformer 640, a motion estimator 1350, a motion compensator 1355, the intra predictor 660, the deblocking filtering unit 670, and the buffer 680.

The multimedia decoding apparatus 1300 generates a restored image by using encoded multimedia data of an input bitstream 1305 and all pieces of information of the multimedia data.

Compared with the conventional video decoding apparatus 400, the multimedia decoding apparatus 1300 further includes the texture attribute information extractor 1310 and the data processing unit determiner 1312. In addition, operations of the motion estimator 1350 and the motion compensator 1355 using a data processing unit determined by the data processing unit determiner 1312 are different from those of the motion estimator 450 and the motion compensator 455 of the conventional video decoding apparatus 400 using a data processing unit according to RDO.

The texture attribute information extractor 1310 according to the exemplary embodiment can extract texture attribute information by using a texture attribute descriptor classified from the input bitstream 1305. For example, if the texture attribute descriptor is any one of metadata regarding an edge histogram, metadata for texture browsing, and metadata regarding texture homogeneity, an edge histogram, an edge orientation, regularity, coarseness, and homogeneity can be extracted as texture attributes.

For example, in an environment based on the MPEG-7 compression standard, the metadata regarding an edge histogram, the metadata for texture browsing, and the metadata regarding texture homogeneity can be an edge histogram descriptor, a texture browsing descriptor, and a homogeneous texture descriptor, respectively.

The data processing unit determiner 1312 can determine the size of a data processing unit for motion estimation of image data by using the texture attributes extracted by the texture attribute information extractor 1310. For example, the data processing unit determiner 1312 can determine the size of the data processing unit by using homogeneity of the texture attributes so that the more homogeneous texture of image data is, the more the size of the data processing unit increases. The data processing unit determiner 1312 may determine the size of the data processing unit by using smoothness of the texture attributes so that the smoother the image data is, the more the size of the data processing unit increases. The data processing unit determiner 1312 may determine the size of the data processing unit by using regularity of the texture attributes so that the more regular a pattern of the image data is, the more the size of the data processing unit increases. Thus, based on the texture components, it can be determined that the size of a data processing unit is small for a part in which an information change is great and the size of a data processing unit is large for a part in which an information change is small.

The motion estimator 1350 and the motion compensator 1355 can respectively perform motion estimation and motion compensation by using the data processing unit determined by the data processing unit determiner 1312.

Compared with the multimedia decoding apparatus 200, the input bitstream 1305 can correspond to the bitstream input through the receiver 210, the texture attribute information extractor 1310 can correspond to the attribute information extractor 220, and the data processing unit determiner 1312 can correspond to the decoding scheme determiner 230. The motion estimator 1350, the motion compensator 1355, the intra predictor 660, the inverse frequency transformer 640, the dequantizer 630, the entropy decoder 620, the deblocking filtering unit 670, and the buffer 680 can correspond to the multimedia data decoder 240.

Multimedia data can be decoded and restored for a bitstream encoded by achieving motion estimation or motion compensation for a current image by using a data processing unit predetermined based on the texture attributes without the necessity of a try of the RDO for all types of data processing units in an encoding end.

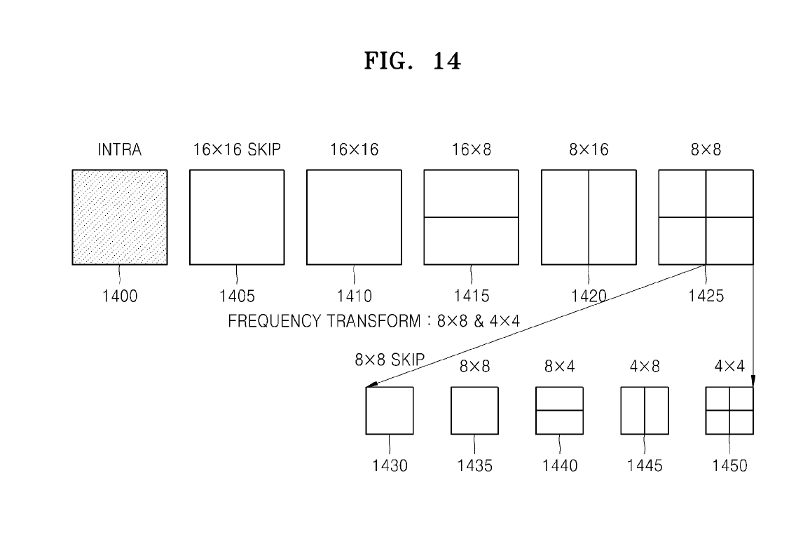

FIG. 14 illustrates types of a prediction mode used in a conventional video encoding method.

In the conventional video encoding method, such as H.264, a 16×16 block 1400 for intra prediction, a 16×16 block 1405 of a skip mode, a 16×16 block 1410 for inter prediction, an inter 16×8 block 1415, an inter 8×16 block 1420, and an inter 8×8 block 1425 can be used as macroblocks for motion estimation (hereinafter, for convenience of description, an M×N block for intra prediction is named as ‘infra M×N block’, an M×N block for inter prediction is named as ‘ inter M×N block’, and an M×N block of a skip mode is named as ‘skip M×N block’). Frequency transform of a macroblock can be performed in an 8×8 or 4×4 block unit.

Each of the macroblocks can be classified into sub blocks such as a skip 8×8 sub block 1430, an inter 8×8 sub block 1435, an inter 8×4 sub block 1440, an inter 4×8 sub block 1445, and an inter 4×4 sub block 1450. Frequency transform of a sub block can be performed in a 4×4 block unit.

According to the conventional video encoding method, after trying RDO by using the blocks 1400, 1405, 1410, 1415, 1420, 1425, 1430, 1435, 1440, 1445, and 1450 shown in FIG. 14 to determine a block for motion estimation, a block having the lowest rate distortion is determined.

In general, a small-size block is selected for an area in which texture is complicated, a lot of detail information exists, or a boundary of an object is located, and a large-size block is selected for a smooth and non-edge area.

However, since the RDO should be tried for blocks having various sizes in every prediction mode according to the conventional video encoding method, an amount of computations for encoding increases, and an additional overhead increases to represent many types of block sizes.

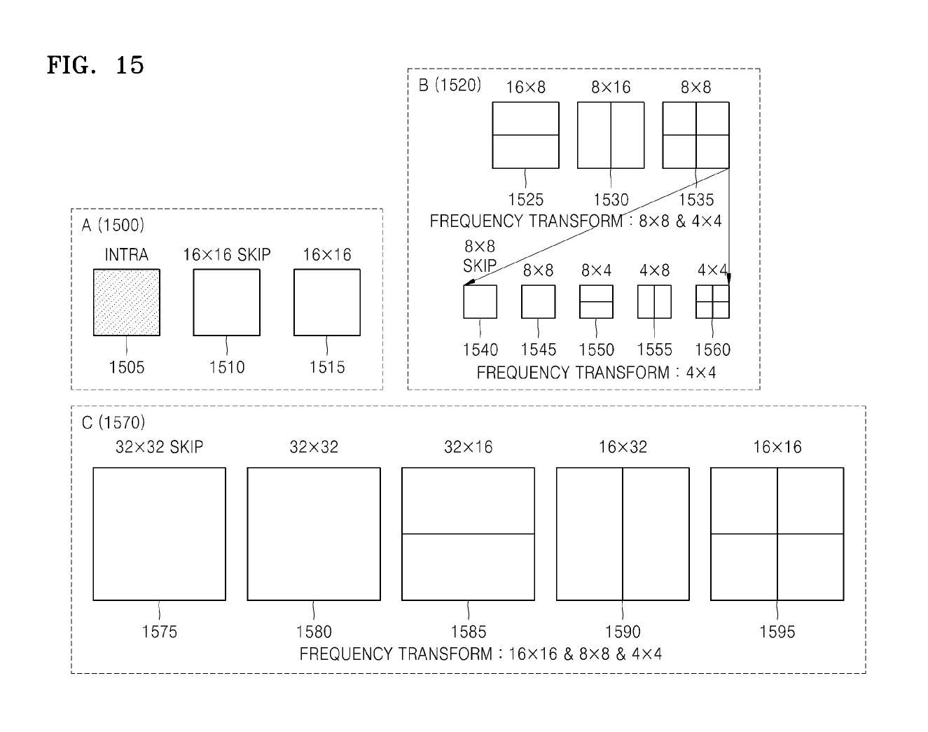

FIG. 15 illustrates types and groups of a prediction mode available in an exemplary embodiment.

The multimedia encoding apparatus 1200 or the multimedia decoding apparatus 1300 may introduce data processing units of 4×4, 8×8, 16×16, or larger sizes.

For example, the multimedia encoding apparatus 1200 can perform motion estimation by using a data processing unit of one of not only an intra 16×16 block 1505, a skip 16×16 block 1510, an inter 16×16 block 1515, an inter 16×8 block 1525, an inter 8×16 block 1530, an inter 8×8 block 1535, a skip 8×8 sub block 1540, an inter 8×8 sub block 1545, an inter 8×4 sub block 1550, an inter 4×8 sub block 1555, and an inter 4×4 sub block 1560, but also a skip 32×32 block 1575, an inter 32×32 block 1580, an inter 32×16 block 1585, an inter 16×32 block 1590, and an inter 16×16 block 1595.

A frequency transform unit of the skip 32×32 block 1575, the inter 32×32 block 1580, the inter 32×16 block 1585, the inter 16×32 block 1590, or the inter 16×16 block 1595 can be one of a 16×16 block, an 8×8 block, and a 4×4 block.

According to the exemplary embodiment, groups for trying the RDO according to texture attributes can be limited by classifying data processing units into groups. For example, the intra 16×16 block 1505, the skip 16×16 block 1510, and the inter 16×16 block 1515 are included in a group A 1500. The inter 16×8 block 1525, the inter 8×16 block 1530, the inter 8×8 block 1535, the skip 8×8 sub block 1540, the inter 8×8 sub block 1545, the inter 8×4 sub block 1550, the inter 4×8 sub block 1555, and the inter 4×4 sub block 1560 are included in a group B 1520. The skip 32×32 block 1575, the inter 32×32 block 1580, the inter 32×16 block 1585, the inter 16×32 block 1590, and the inter 16×16 block 1595 are included in a group C 1570.

The data processing unit determiners 1212 or 1312 increases the size of a data processing unit in the order of the group B 1520, the group A 1500, and the group C 1570.

FIG. 16 illustrates a method of determining a data processing unit using texture, according to an exemplary embodiment.

When a data processing unit is determined from among the data processing unit groups, i.e., the group B 1520, the group A 1500, and the group C 1570, illustrated in FIG. 15, analysis of texture components must be performed in advance.

That is, texture information can be detected by analyzing texture of a slice in the texture attribute detector 1210 and analyzing a texture attribute descriptor of the slice in the texture attribute extractor 1310. For example, the texture components can be defined as homogeneity, regularity, and stochasticity.

When texture of a current slice is defined as ‘homogeneous’, the data processing unit determiners 1212 or 1312 can determine an object of an RDO try for the current slice as a large-size data processing unit. For example, an optimal data processing unit for the current slice can be determined by trying the RDO with the data processing units in the group A 1500 and the group C 1570.

When texture of a current slice is defined as ‘irregular’ or ‘stochastic’, the data processing unit determiners 1212 or 1312 can determine an object of an RDO try for the current slice as a small-size data processing unit. For example, an optimal data processing unit for the current slice can be determined by trying the RDO with the data processing units in the group B 1520 and the group A 1500.

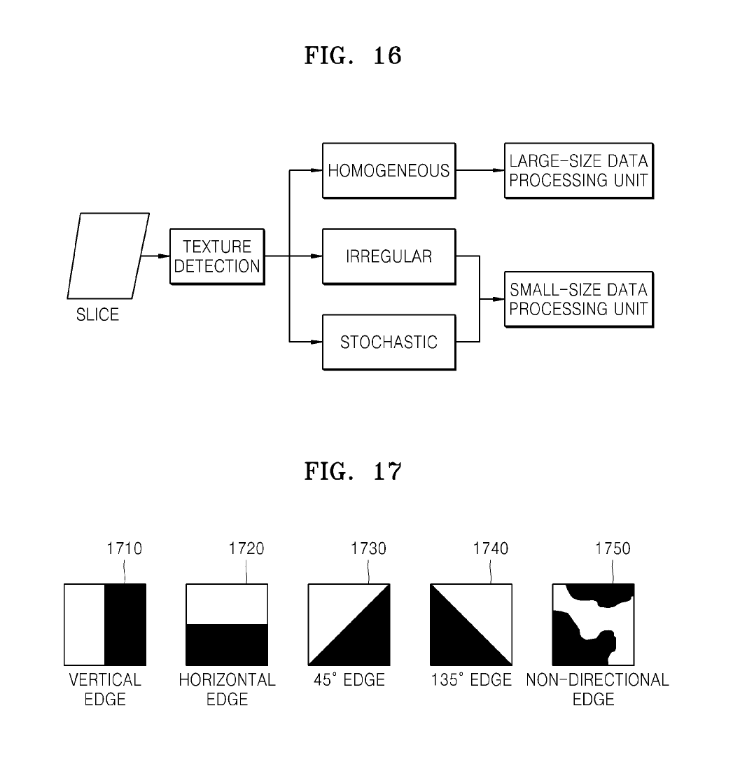

FIG. 17 illustrates edge types used as texture attributes, according to an exemplary embodiment.

The edge types of the texture attributes can be identified according to a direction. For example, orientation of edges used in an edge histogram descriptor or a texture browsing descriptor can be defined as five types of a vertical edge 1710, a horizontal edge 1720, a 45° edge 1730, a 135° edge 1740, and a non-directional edge 1750. Thus, the texture attribute detector 1210 or the texture attribute extractor 1310 according to the exemplary embodiment can select an edge of image data as one of the five types of edges, namely, the vertical, horizontal, 45°, 135°, and non-directional edges 1710, 1720, 1730, 1740, and 1750.

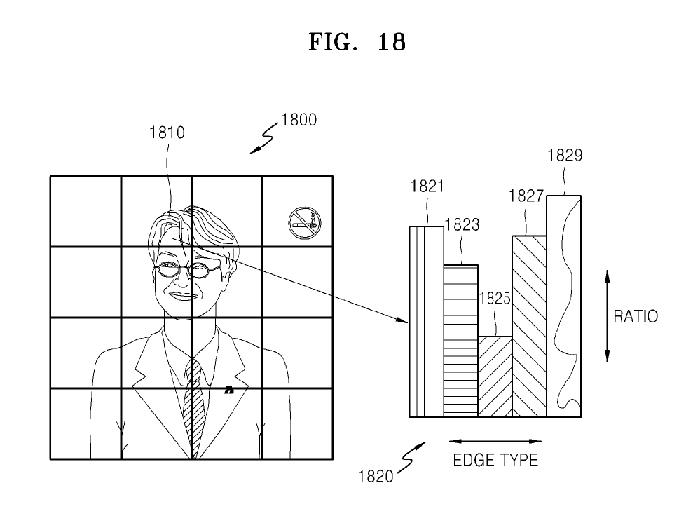

FIG. 18 illustrates an edge histogram used as texture attributes, according to an exemplary embodiment.

The edge histogram defines a spatial distribution of the five types of edges, such as the vertical edge 1710, the horizontal edge 1720, the 45° edge 1730, the 135° edge 1740, and the non-directional edge 1750, by analyzing edge components of an image area. Various histograms having semi-global and global patterns can be generated.

For example, an edge histogram 1820 represents a spatial distribution of edges of a sub image 1810 of an original image 1800. Thus, the five types of edges, namely, the vertical, horizontal, 45°, 135°, and non-directional edges 1710, 1720, 1730, 1740, and 1750 of the sub image 1810 are distributed into a vertical edge ratio 1821, a horizontal edge ratio 1823, a 45° edge ratio 1825, a 135° edge ratio 1827, and a non-directional edge ratio 1829.

The original image 1800 is divided into 16 sub images, and the five types of edges are measured for each sub image, and thus 80 pieces of edge information can be extracted. Accordingly, an edge histogram descriptor for a current image includes the 80 pieces of edge information, and a length of a histogram descriptor is 240 bits. When a spatial distribution of a predetermined edge is great in an edge histogram, a corresponding area can be identified as a detail region, and when a spatial distribution of a predetermined edge is small in an edge histogram, a corresponding area can be identified as a smooth region.

A texture browsing descriptor describes attributes of texture included in an image by digitizing regularity, orientation, and coarseness of the texture based on human visual attributes. If a first value of a texture browsing descriptor for a current area is great, the current area can be classified to an area having more regular texture.

A homogeneous texture descriptor divides a frequency channel of an image into 30 channels by using a Gabor filter and describes homogeneous texture attributes of the image by using energy of each channel and an energy standard deviation. If energy of homogeneous texture components for a current area is great and an energy standard deviation is small, the current area can be classified to a homogeneous region.

Thus, texture attributes can be analyzed from a texture attribute descriptor according to an exemplary embodiment, and a syntax indicating a data processing unit for motion estimation can be defined according to a texture grade.

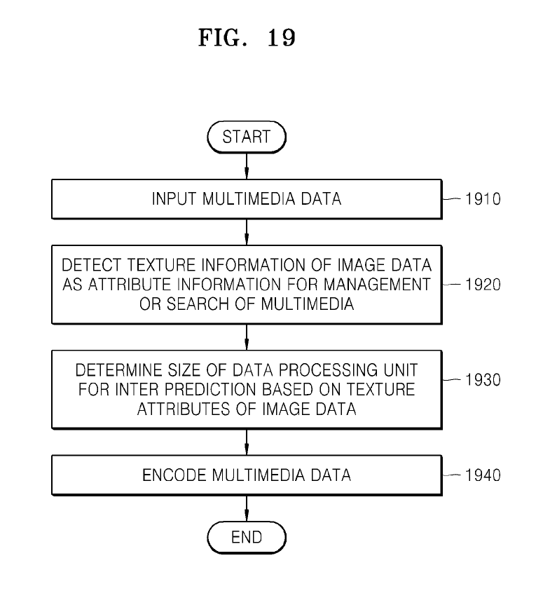

FIG. 19 is a flowchart of a multimedia encoding method, according to an exemplary embodiment.

Referring to FIG. 19, multimedia data is input in operation 1910.

In operation 1920, texture attributes of image data are detected as attribute information for management or search of multimedia. The texture attributes can be defined as edge orientation, coarseness, smoothness, regularity, and stochasticity.

In operation 1930, the size of a data processing unit for inter prediction can be determined based on texture attributes of the image data. In particular, an optimal data processing unit can be determined by classifying data processing units into groups and performing RDO only for data processing units in a mapped group. Data processing units can be determined for intra prediction and skip mode besides inter prediction.

In operation 1940, motion estimation and motion compensation for the image data are performed by using the optimal data processing unit determined based on the texture attributes. Encoding of the image data is performed through intra prediction, frequency transform, quantization, deblocking filtering, and entropy encoding.

According to the multimedia encoding apparatus 1200 and the multimedia encoding method, an optimal data processing unit for motion estimation can be determined by using a texture attribute descriptor providing a search and summary function of multimedia content information. Since types of data processing units for performing RDO are limited, a size of a syntax for representing the data processing units can be reduced, and an amount of computations for the RDO can also be reduced.

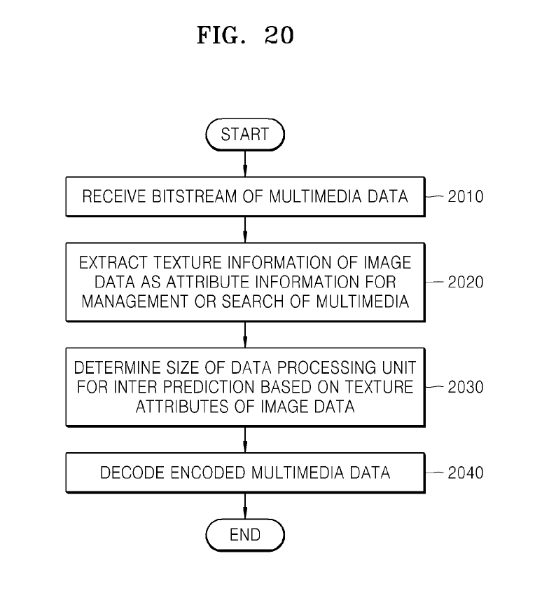

FIG. 20 is a flowchart of a multimedia decoding method based on texture attributes of multimedia, according to the embodiment of the present invention.

Referring to FIG. 20, a bitstream of multimedia data is received in operation 2010. The bitstream can be parsed and classified into encoded multimedia data and information data regarding the multimedia.

In operation 2020, texture information of image data can be extracted as attribute information for management or search of multimedia. The attribute information for management or search of multimedia can be extracted from a descriptor for management and search of multimedia information based on the attributes of multimedia content.

In operation 2030, the size of a data processing unit for motion estimation can be determined based on texture attributes of the image data. In particular, data processing units for inter prediction can be classified into a plurality of groups according to sizes. A different group is mapped according to a texture level, and RDO can be performed by using only data processing units in a group mapped to a texture level of current image data. A data processing unit having the lowest rate distortion from among the data processing units in the group can be determined as an optimal data processing unit.

In operation 2040, the encoded multimedia data can be restored to multimedia data by being decoded through motion estimation and motion compensation using the optimal data processing unit, entropy decoding, dequantization, inverse frequency transform, intra prediction, and deblocking filtering.

According to the multimedia decoding apparatus 1300 or the multimedia decoding method according to the embodiment of the present invention, an amount of computations for RDO to find an optimal data processing unit by using a descriptor available for information search or summary of image content can be reduced, and a size of a syntax for representing the optimal data processing unit can be reduced.

The embodiment of the present invention for encoding or decoding image data based on the texture attributes of the content attributes will now be described with reference to FIGS. 21 to 29.

FIG. 21 is a block diagram of a multimedia encoding apparatus 2100, according to an exemplary embodiment.

Referring to FIG. 21, the multimedia encoding apparatus 2100 includes a texture attribute information detector 2110, an intra mode determiner 2112, an texture attribute descriptor encoder 2115, the motion estimator 520, the motion compensator 525, an intra predictor 2130, the frequency transformer 540, the quantizer 550, the entropy encoder 560, the inverse frequency transformer 570, the deblocking filtering unit 580, the buffer 590, and a texture attribute descriptor encoder 2115.

The multimedia encoding apparatus 2100 generates a bitstream 2165 encoded by omitting redundant data by using the temporal redundancy of consecutive images and the spatial redundancy in the same image of the input sequence 505.

Compared with the conventional video encoding apparatus 300, the multimedia encoding apparatus 2100 further includes the texture attribute information detector 2110, the intra mode determiner 2112, and the texture attribute descriptor encoder 2115. In addition, an operation of the intra predictor 2130 using a data processing unit determined by the intra mode determiner 2112 is different from that of the intra predictor 330 of the conventional video encoding apparatus 300.

The texture attribute information detector 2110 extracts texture components by analyzing the input sequence 505. For example, the texture components can be homogeneity, smoothness, regularity, edge orientation, and coarseness.

The intra mode determiner 2112 can determine the size of a data processing unit for motion estimation of image data by using the texture attributes detected by the texture attribute information detector 2110. The data processing unit can be a rectangular type block.

For example, the intra mode determiner 2112 can determine a type and direction of a predictable intra prediction mode for current image data based on a distribution of an edge direction of the texture attributes of the image data.

In particular, priority can be determined according to a type and direction of a predictable intra prediction mode. The intra mode determiner 2112 can create an intra prediction mode table, in which priorities are allocated in the order of dominant edge directions, based on a spatial distribution of the five types of edges.

The intra predictor 2130 can perform intra prediction by using the intra prediction mode determined by the intra mode determiner 2112.

If the texture attribute detected by the texture attribute information detector 2110 is an edge histogram, the texture attribute descriptor encoder 2115 can encode metadata regarding the edge histogram by using edge histogram information. Alternatively, if the texture attribute detected by the texture attribute information detector 2110 is edge orientation, the texture attribute descriptor encoder 2115 can encode metadata for texture browsing or metadata regarding texture homogeneity by using texture information.

For example, in an environment of the MPEG-7 compression standard, the metadata regarding the edge histogram, the metadata for texture browsing, and the metadata regarding texture homogeneity can be an edge histogram descriptor, a texture browsing descriptor, and a homogeneous texture descriptor, respectively.

Each of the metadata regarding the edge histogram, the metadata for texture browsing, and the metadata regarding texture homogeneity corresponds to a descriptor for management and search of information regarding multimedia content.

The texture attribute descriptor encoded by the texture attribute descriptor encoder 2115 can be included in the bitstream 2165 with the encoded multimedia data. Alternatively, the texture attribute descriptor encoded by the texture attribute descriptor encoder 2115 may be output as a bitstream different from that in which the encoded multimedia data is included.

Compared with the multimedia encoding apparatus 100, the input sequence 505 can correspond to the image input through the input unit 110, the texture attribute information detector 2110 can correspond to the attribute information detector 120, and the intra mode determiner 2112 can correspond to the encoding scheme determiner 130. The motion estimator 520, the motion compensator 525, the intra predictor 2130, the frequency transformer 540, the quantizer 550, the entropy encoder 560, the inverse frequency transformer 570, the deblocking filtering unit 580, and the buffer 590 can correspond to the multimedia data encoder 140.

Since intra prediction for a current image is achieved by using an intra prediction mode predetermined based on the texture attributes, it becomes unnecessary to perform the intra prediction for all edge directions, and an amount of computations for encoding can be reduced.

FIG. 22 is a block diagram of a multimedia decoding apparatus 2200, according to an exemplary embodiment.

Referring to FIG. 22, the multimedia decoding apparatus 22 includes a texture attribute information extractor 2210, an intra mode determiner 2212, the entropy decoder 620, the dequantizer 630, the inverse frequency transformer 640, the motion estimator 650, the motion compensator 655, an intra predictor 2260, the deblocking filtering unit 670, and the buffer 680.

The multimedia decoding apparatus 2200 generates a restored image by using encoded multimedia data of an input bitstream 2205 and all pieces of information of the multimedia data.

Compared with the conventional video decoding apparatus 400, the multimedia decoding apparatus 2200 further includes the texture attribute information extractor 2210 and the intra mode determiner 2212. In addition, an operation of the intra predictor 2260 using an intra prediction mode determined by the intra mode determiner 2212 is different from that of the intra predictor 460 of the conventional video decoding apparatus 400.

The texture attribute information extractor 2210 can extract texture attribute information by using a texture attribute descriptor classified from the input bitstream 2205. For example, if the texture attribute descriptor is any one of metadata regarding an edge histogram, metadata for texture browsing, and metadata regarding texture homogeneity, an edge histogram and edge orientation can be extracted as texture attributes.

For example, in an environment based on the MPEG-7 compression standard, the metadata regarding an edge histogram, the metadata for texture browsing, and the metadata regarding texture homogeneity can be an edge histogram descriptor, a texture browsing descriptor, and a homogeneous texture descriptor, respectively.

The intra mode determiner 2212 can determine a type and direction of an intra prediction mode for intra prediction of the image data by using the texture attributes extracted by the texture attribute information extractor 2210. In particular, priority can be determined according to a type and direction of a predictable intra prediction mode. The intra mode determiner 2212 can create an intra prediction mode table, in which priorities are allocated in the order of dominant edge directions, based on a spatial distribution of the five types of edges.

The intra predictor 2260 can perform intra prediction for the image data by using the intra prediction mode determined by the intra mode determiner 2212.

Compared with the multimedia decoding apparatus 200, the input bitstream 2205 can correspond to the bitstream input through the receiver 210, the texture attribute information extractor 2210 can correspond to the attribute information extractor 220, and the intra mode determiner 2212 can correspond to the decoding scheme determiner 230. The motion estimator 650, the motion compensator 655, the intra predictor 2260, the inverse frequency transformer 640, the dequantizer 630, the entropy decoder 620, the deblocking filtering unit 670, and the buffer 680 can correspond to the multimedia data decoder 240.

Multimedia data can be decoded and restored for a bitstream encoded by achieving intra prediction for a current image by using an intra prediction mode predetermined based on the texture attributes without performing the intra prediction for all types and directions of intra prediction modes. Accordingly, since it is not required to perform intra prediction according to all types and directions of the intra prediction modes, an amount of computations for intra prediction can be reduced. Since a descriptor for an information search function is used without the necessity of separate detection of content attributes, there is no need for providing separate bits.

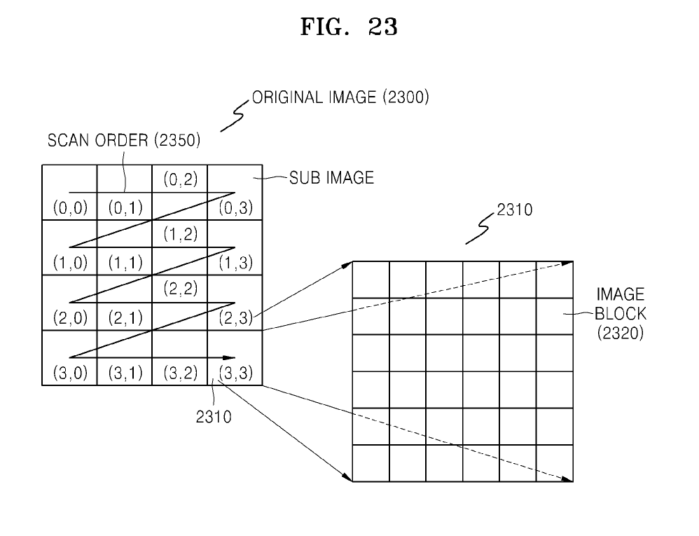

FIG. 23 illustrates a relationship among an original image, a sub image, and an image block.

Referring to FIG. 23, an original image 2300 is divided into 16 sub images, where (n, m) denotes a sub image in an n^{th} column and an m^{th} row. Encoding of the original image 2300 can be performed according to a scan order 2350 for the sub images. A sub image 2310 is divided into blocks such as an image block 2320.

Edge analysis of the original image 2300 is achieved by detecting edge attributes per sub image, and edge attributes of a sub image can be defined by a direction and intensity of an edge of each of blocks of the sub image.

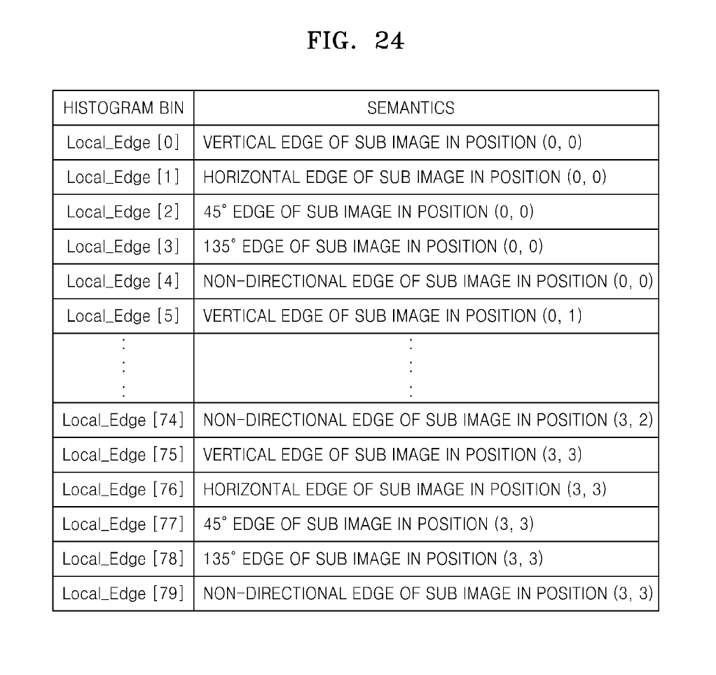

FIG. 24 illustrates semantics of an edge histogram descriptor of a sub image.

The semantics of an edge histogram descriptor for the original image 2300 indicate the intensity of en edge according to edge directions of every sub image. Here, ‘Local_Edge[n]’ per histogram bin denotes the edge intensity of an n^{th} bin. Herein, n denotes an index representing the five types of edge directions for every 16 sub images and is an integer from 0 to 79. That is, a total of 80 histogram bins are defined for the original image 2300.

‘Local_Edge[n]’ sequentially indicates the intensity of five types of edges for sub images located according to the scan order 2350 of the original image 2300. Thus, for a sub image in a position (0, 0) as an example, ‘Local_Edge [0],’ ‘Local_Edge[1],’ ‘Local_Edge[2],’ ‘Local_Edge[3],’ and ‘Local_Edge[4]’ indicate the intensity of a vertical edge, a horizontal edge, a 45° edge, a 135° edge, and a non-directional edge of the sub image in the position (0, 0), respectively.

Since 3 bits for the intensity of en edge are allocated to each of the 80 histogram bins, the edge histogram descriptor can be represented with a total of 240 bits.

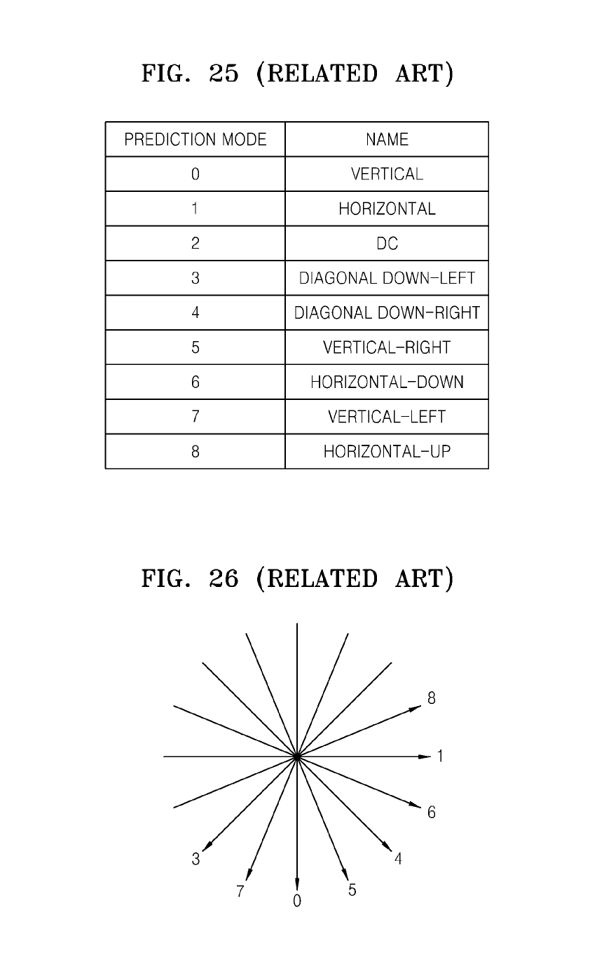

FIG. 25 is a table of intra prediction modes of the conventional video encoding method.

Referring to FIG. 25, the table of intra prediction modes of the conventional video encoding method allocates prediction mode numbers to all intra prediction directions. That is, prediction mode numbers 0, 1, 2, 3, 4, 5, 6, 7, and 8 are allocated to a vertical direction, a horizontal direction, a DC direction, a diagonal down-left direction, a diagonal down-right direction, a vertical-right direction, a horizontal-down direction, a vertical-left direction, and a horizontal-up direction, respectively.

A type of an intra prediction mode depends on whether to predict the type by using a DC value of a corresponding area, and a direction of the intra prediction mode indicates a direction in which a neighboring reference area is located.

FIG. 26 illustrates directions of the intra prediction modes of the conventional video encoding method.

Referring to FIG. 26, according to intra prediction, a pixel value of a current area can be predicted by using a pixel value of a neighboring area in an intra prediction direction corresponding to a prediction mode number. That is, according to a type and direction of an intra prediction mode, the current area can be predicted by using one of a neighboring area in the vertical direction 0, a neighboring area in the horizontal direction 1, the DC direction 2, a neighboring area in the diagonal down-left direction 3, a neighboring area in the diagonal down-right direction 4, a neighboring area in the vertical-right direction 5, a neighboring area in the horizontal-down direction 6, a neighboring area in the vertical-left direction 7, and a neighboring area in the horizontal-up direction 8.

FIG. 27 is a reconstructed table of intra prediction modes, according to an exemplary embodiment.

Referring to FIG. 27, the intra mode determiner 2112 or 2212 can determine a predictable intra prediction mode based on texture components of current image data. For example, a predictable intra prediction direction or a type of an intra prediction mode can be determined based on edge orientation of the texture components.

The intra mode determiner 2112 or 2212 can reconstruct a table of intra prediction modes by using a predictable intra prediction direction or a type of an intra prediction mode. For example, at least one dominant edge direction is detected by using texture attributes of current image data, and only an intra prediction mode type and an intra prediction direction corresponding to the detected dominant edge direction can be selected as a predictable intra prediction mode. Accordingly, an amount of computations for performing intra prediction for every intra prediction direction and type can be reduced.

In addition, the intra mode determiner 2112 or 2212 can include only predictable intra prediction modes in an intra prediction mode table. As priority of an intra prediction direction or type in the intra prediction mode table increases, a probability of being selected as an optimal intra prediction mode can also increase. Thus, the intra mode determiner 2112 or 2212 can adjust priorities in the intra prediction mode table by allocating a lower intra prediction number (corresponding to higher priority) to an intra prediction direction or type corresponding to an edge direction having a greater distribution.

For example, according to the table shown in FIG. 27, as a result of analysis of an edge histogram of a current area, distributions of a vertical edge, a horizontal edge, a 45° edge, a 135° edge, and a non-directional edge are 30%, 10%, 0%, 0%, and 60%, respectively. Accordingly, if an intra prediction mode table is reconstructed, DC that is an intra prediction direction corresponding to the non-directional edge has the highest priority, and the lowest intra prediction number 0 is allocated to the DC. Intra prediction directions of the vertical direction and the horizontal direction are selected for the vertical edge and the horizontal edge largely distributed in the current area in the next order, and intra prediction numbers 1 and 2 are allocated to the vertical edge and the horizontal edge, respectively.

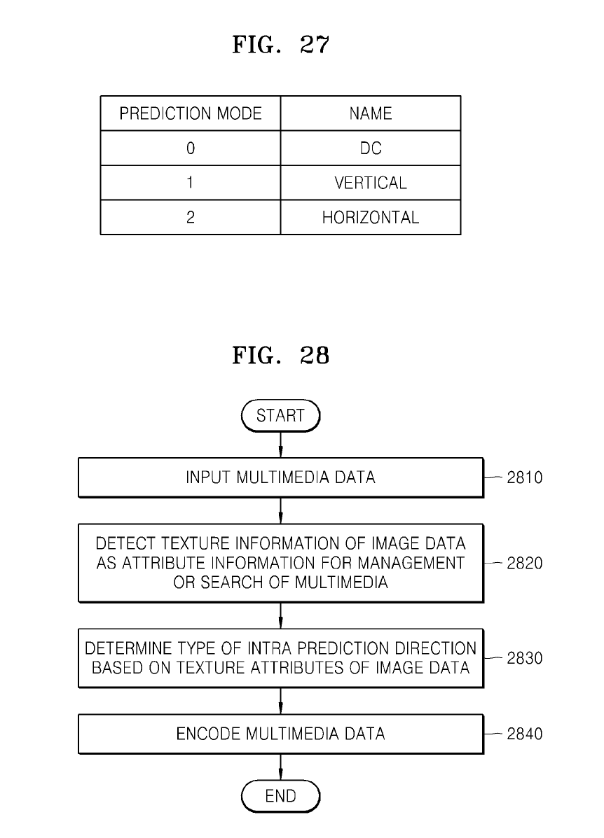

FIG. 28 is a flowchart of a multimedia encoding method, according to an exemplary embodiment.

Referring to FIG. 28, multimedia data is input in operation 2810. In operation 2820, texture attributes of image data are detected as attribute information for management or search of multimedia. The texture attributes can be defined as edge orientation and edge histogram.

In operation 2830, an intra prediction direction for intra prediction can be determined based on the texture attributes of the image data. In particular, only types and directions of predictable intra prediction modes can be included in an intra prediction mode table, and priorities of the types and directions of the predictable intra prediction modes can be adjusted.

In operation 2840, intra prediction for the image data is performed by using an optimal intra prediction mode determined based on the texture attributes. Encoding of the image data is performed through motion estimation, motion compensation, frequency transform, quantization, deblocking filtering, and entropy encoding.

According to the multimedia encoding apparatus 2100 and the multimedia encoding method, a direction and type of an optimal intra prediction mode for intra prediction can be determined by using a texture attribute descriptor providing a search and summary function of multimedia content information. Since the number of intra prediction modes for performing intra prediction on a trial basis to determine the optimal intra prediction mode is limited, a size of a syntax for representing data processing units can be reduced, and an amount of computations can also be reduced.

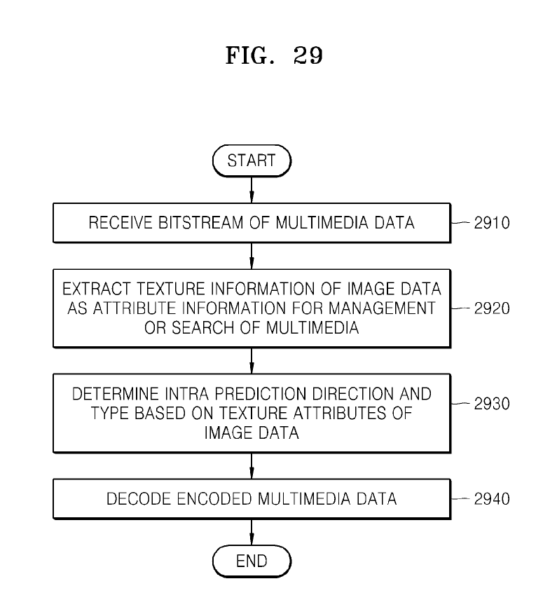

FIG. 29 is a flowchart of a multimedia decoding, according to an exemplary embodiment.

Referring to FIG. 29, a bitstream of multimedia data is received in operation 2910. The bitstream can be parsed and classified into encoded multimedia data and information data regarding the multimedia.

In operation 2920, texture information of image data can be extracted as attribute information for management or search of multimedia. The attribute information for management or search of multimedia can be extracted from a descriptor for management and search of multimedia information based on the attributes of multimedia content.

In operation 2930, an intra prediction direction and type for intra prediction can be determined based on the texture attributes of the image data. In particular, only types and directions of predictable intra prediction modes can be included in an intra prediction mode table, and priorities of the types and directions of the predictable intra prediction modes can be modified.

In operation 2940, the encoded multimedia data can be restored to multimedia data by being decoded through intra prediction for an optimal intra prediction mode, motion estimation, motion compensation, entropy decoding, dequantization, inverse frequency transform, and deblocking filtering.

According to the multimedia decoding apparatus 2200 or the multimedia decoding method, an amount of computations for intra prediction to find an optimal intra prediction mode by using a descriptor available for information search or summary of image content can be reduced, and a size of a syntax for representing all predictable intra prediction modes can be reduced.

An exemplary embodiment for encoding or decoding image data based on the texture attributes of the content attributes will now be described with reference to FIGS. 30 to 35.

FIG. 30 is a block diagram of a multimedia encoding apparatus 3000, according to an exemplary embodiment.

Referring to FIG. 30, the multimedia encoding apparatus 3000 includes a speed attribute detector 3010, a window length determiner 3020, a sound encoder 3030, and a speed attribute descriptor encoder 3040.

The multimedia encoding apparatus 3000 generates a bitstream 3095 encoded by omitting redundant data by using the temporal redundancy of consecutive signals of the input signal 3005.

The speed attribute detector 3010 extracts speed components by analyzing the input signal 3005. For example, the speed components can be tempo. The tempo is terminology used in a structured audio among MPEG audios and denotes a proportional variable indicating a relationship between a score time and an absolute time. A tempo with a great number means ‘fast,’ and 120 beats per minute (BPM) means two times faster than 60 BPM.

The window length determiner 3020 can determine a data processing unit for frequency transform by using speed attributes detected by the speed attribute detector 3010. Although the data processing unit can include ‘frame’ and ‘window,’ ‘window’ will be used for convenience of description.

In addition, the window length determiner 3020 can determine a length of a window or a weight by considering the speed attributes. For example, the window length determiner 3020 can determine the window length to be shorter when a tempo of current sound data is fast and the window length to be longer when the tempo is slow.

If speed information extracted by the speed attribute detector 3010 is not valid information, the window length determiner 3020 can determine a window having a fixed length and type. For example, if the input signal 3005 is a natural sound signal, constant speed information cannot be extracted, so the natural sound signal can be encoded by using a fixed window.

The sound encoder 3030 can perform frequency transform of sound data by using the window determined by the window length determiner 3020. The frequency-transformed sound data is encoded through quantization. For example, in an environment of the MPEG-7 compression standard, metadata regarding an audio tempo can be an audio tempo descriptor.

When the speed attributes detected by the speed attribute detector 3010 is a tempo, the speed attribute descriptor encoder 3040 can encode a speed attribute descriptor to metadata regarding an audio tempo, semantic description information, and side information by using tempo information.

The speed attribute descriptor encoded by the speed attribute descriptor encoder 3040 can be included in the bitstream 3095 as the encoded multimedia data was. Alternatively, the speed attribute descriptor encoded by the speed attribute descriptor encoder 3040 may be output as a bitstream different from that in which the encoded multimedia data is included.

Compared with the multimedia encoding apparatus 100, the input signal 3005 can correspond to the image input through the input unit 110, the speed attribute detector 3010 can correspond to the attribute information detector 120, and the window length determiner 3020 can correspond to the encoding scheme determiner 130. The sound encoder 3030 can correspond to the multimedia data encoder 140.

Accordingly, the multimedia encoding apparatus 3000 can encode sound data including relatively correct detail information with a relatively small number of beats by considering speed attributes of the sound data, and by determining a window length to be used for frequency transform for encoding of the sound data by using speed attributes detected for information management or search of the sound data.

In addition, since information detected to generate a descriptor for searching for content information is used without needing a separate process for detecting the speed attributes of sound data, efficient data encoding can be performed.

FIG. 31 is a block diagram of a multimedia decoding apparatus 3100, according to an exemplary embodiment.

Referring to FIG. 31, the multimedia decoding apparatus 3100 includes a speed attribute information extractor 3110, a window length determiner 3120, and a sound decoder 3130.

The multimedia decoding apparatus 3100 generates a restored sound 3195 by using encoded sound data of an input bitstream 3105 and all pieces of information of the sound data.

The speed attribute information extractor 3110 can extract speed attribute information by using a speed attribute descriptor classified from the input bitstream 3105. For example, if the speed attribute descriptor is any one of metadata regarding an audio tempo, semantic description information, and side information, tempo information can be extracted as the speed attributes. The metadata regarding an audio tempo can be an audio tempo descriptor in an environment of the MPEG-7 compression standard.

The window length determiner 3120 can determine a window for frequency transform by using speed attributes extracted by the speed attribute information extractor 3110. The window length determiner 3120 can determine a window length or a window type. The window length means the number of coefficients included in a window. The window type can include a symmetrical window and an asymmetrical window.

The sound decoder 3130 can decode the input bitstream 3105 by performing inverse frequency transform by using the window determined by the window length determiner 3120, thereby generating the restored sound 3195.

Compared with the multimedia decoding apparatus 200, the input bitstream 3105 can correspond to the bitstream input through the receiver 210, the speed attribute information extractor 3110 can correspond to the attribute information extractor 220, and the window length determiner 3120 can correspond to the decoding scheme determiner 230. The sound decoder 3130 can correspond to the multimedia data decoder 240.

Since a window for frequency transform is determined by considering speed attributes of sound data, the sound data can be effectively restored, and since content attributes are extracted from a descriptor for information search and used without extracting separate attribute information, the sound data can be efficiently restored.

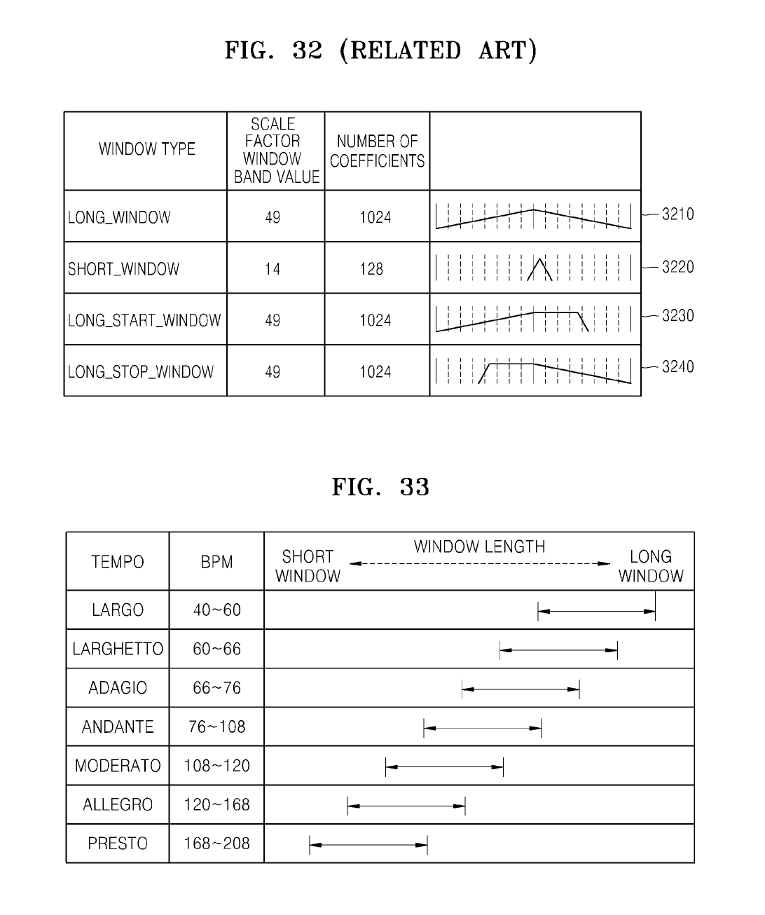

FIG. 32 is a table of windows used in a conventional audio encoding method.

Since similar patterns are repeated in a sound signal, it is advantageous that predetermined signal processing is performed by transforming the sound signal to a frequency domain, rather than computation of the sound signal being performed in a time domain. In order to transform the sound signal to the frequency domain, data is divided into predetermined units, each of which is called a frame or window. Since a length of a frame or window determines resolution in the time domain or the frequency domain, an optimal frame or window length must be selected by considering attributes of an input signal in encoding/decoding efficiency.

The table illustrated in FIG. 32 shows window types of Advanced Audio Coding (AAC), one of representative audio codecs. There are two types of window lengths, a window length including 1024 coefficients, such as windows 3210, 3230, and 3240, and a window length including 128 coefficients, such as a window 3220.

For a window type, symmetrical windows are the window 3210 ‘LONG_WINDOW’ including 1024 coefficients and having a long window length and the window 3220 ‘ SHORT_WINDOW’ including 128 coefficients and having a short window length, and asymmetrical windows are the window 3230 ‘LONG START WINDOW’ of which a window start portion is long and the window 3240 ‘LONG STOP WINDOW’ of which a window stop portion is long.

Relatively high frequency resolution can be achieved by applying the window 3210 ‘LONG_WINDOW’ to a steady-state signal, and a temporal change can be relatively well represented by applying the window 3220 ‘SHORT_WINDOW’ to a signal of which a change is fast or a signal in which a rapid change exists, such as an impulse signal.

In a case of a long window length such as the window 3210, since a signal is represented by using a great number of bases for frequency transform, a minute signal change in the frequency domain can be represented. However, in a case of a window having a long window length, since a temporal change cannot be represented in the same window, distortion, such as a pre-echo effect, may occur due to no proper representation of a rapidly changed signal in the window.

In a case of a short window length such as the window 3220, a temporal change can be effectively represented. However, when a window having a short window length is applied to a steady-state signal, a signal repeatedly overlapping in a plurality of windows may be represented without proper reflection of redundancy between windows, so encoding efficiency may be degraded.

FIG. 33 illustrates a relationship of adjusting a window length based on tempo information of sound, according to an exemplary embodiment.

Referring to FIG. 33, the window length determiner 3020 or 3120 determines a window length based on speed attributes. Under the consideration of tempo information or BPM information, since a transition interval frequently occurs in the same length in a case of sound data with a fast tempo, the window length determiner 3020 or 3120 selects a window having a short length for frequency transform of the sound data. In addition, since a transition interval occurs rarely in the same length in a case of sound data with a slow tempo, the window length determiner 3020 or 3120 selects a window having a long length for frequency transform of the sound data.

For example, like the table of FIG. 33, since a tempo is faster and BPM is greater in a direction of largo, larghetto, adagio, andante, moderato, allegro, and presto, it can be determined that a window length is shorter on a step-by-step basis.

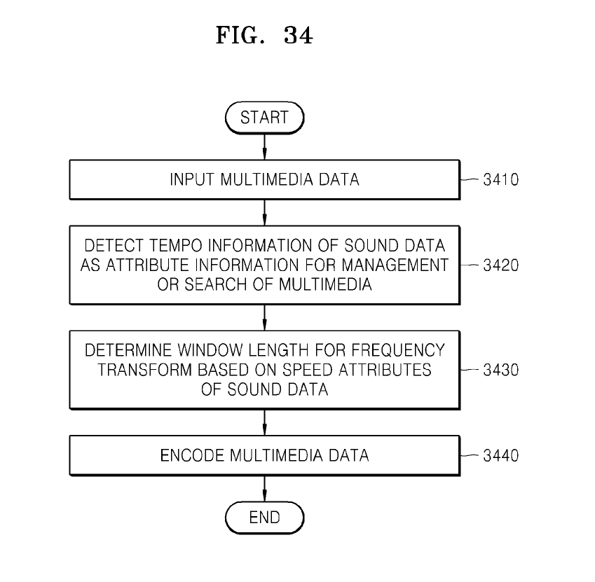

FIG. 34 is a flowchart of a multimedia encoding method, according to an exemplary embodiment.

Referring to FIG. 34, multimedia data is input in operation 3410.

In operation 3420, speed attributes of sound data are detected as attribute information for management or search of multimedia. The speed attributes can be defined with a tempo and BPM.

In operation 3430, a window length for frequency transform can be determined based on the speed attributes of sound data. Not only the window length but also a window type may be determined. A window having a relatively short length can be determined for fast sound data, and a window having a relatively long length can be determined for slow sound data.

In operation 3440, frequency transform for the sound data is performed by using a window determined based on the speed attributes. Encoding of the sound data is performed through frequency transform, and quantization.

According to the multimedia encoding apparatus 3000 and the multimedia encoding method, a window length for frequency transform can be determined by using a speed attribute descriptor providing a search and summary function of multimedia content information. More accurate and efficient encoding can be performed by selecting a window based on speed attributes of sound data.

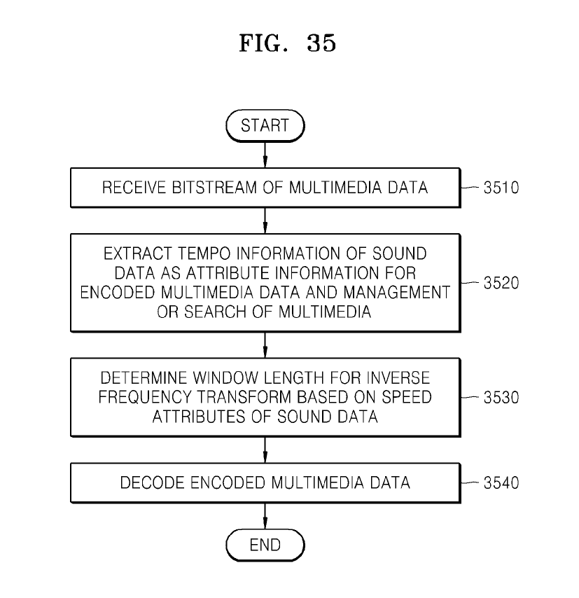

FIG. 35 is a flowchart of a multimedia decoding method, according to an exemplary embodiment.

Referring to FIG. 35, a bitstream of multimedia data is received in operation 3510. The bitstream can be parsed and classified into encoded multimedia data and information data regarding the multimedia.

In operation 3520, speed information of sound data can be extracted as attribute information for management or search of multimedia. The attribute information for management or search of multimedia can be extracted from a descriptor for management and search of multimedia information based on the attributes of multimedia content.

In operation 3530, a window length for frequency transform can be determined based on the speed attributes of the sound data. A window length and type may be determined. The faster the sound data, a shorter window can be determined, and the slower the sound data, a longer window can be determined.

In operation 3540, the encoded multimedia data can be restored to sound data by being decoded through frequency transform using a window having an optimal length, and dequantization.

According to the multimedia decoding apparatus 3100 or the multimedia decoding method, an amount of computations for frequency transform can be optimized and a signal change in a window can be more accurately represented, by finding a window having an optimal length by using a descriptor available for information search or summary of sound content.

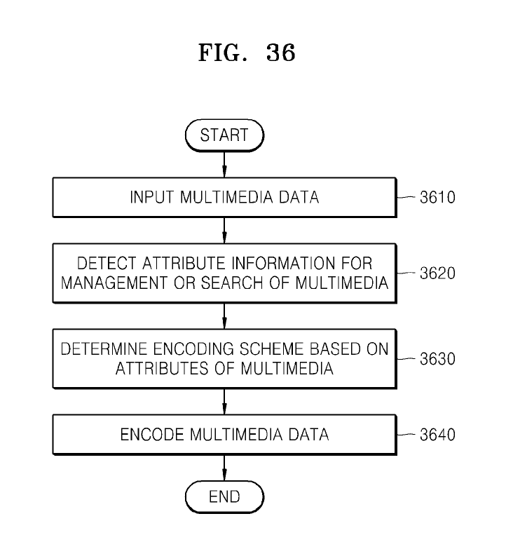

FIG. 36 is a flowchart of a multimedia encoding method, according to an exemplary embodiment.

Referring to FIG. 36, multimedia data is input in operation 3610. The multimedia data can include image data and sound data.

In operation 3620, attribute information for management or search of multimedia based on predetermined attributes of multimedia content is detected by analyzing the input multimedia data. The predetermined attributes of multimedia content can include color attributes of image data, texture attributes of image data, and speed attributes of sound data. For example, the color attributes of image data can include a color layout and a color histogram of an image. The texture attributes of image data can include homogeneity, smoothness, regularity, edge orientation, and coarseness of image texture. For example, the speed attributes of sound data can include tempo information of a sound.

In operation 3630, an encoding scheme based on attributes of multimedia is determined by using the attribute information for management or search of multimedia. For example, a compensation value of a brightness variation can be determined based on the color attributes of image data. The size of a data processing unit and a prediction mode used in inter prediction can be determined based on the texture attributes of image data. An available intra prediction type and direction can be determined based on the texture attributes of image data. A window length for frequency transform can be determined based on the speed attributes of sound data.

In operation 3640, the multimedia data is encoded according to an encoding scheme based on the attributes of multimedia. The encoded multimedia data can be output in the form of a bitstream. The multimedia data can be encoded by performing processes, such as motion estimation, motion compensation, intra prediction, frequency transform, quantization, and entropy encoding.

According to an encoding scheme determined by considering the attributes of multimedia content, at least one of motion estimation, motion compensation, intra prediction, frequency transform, quantization, and entropy encoding can be performed. For example, if a compensation value of a brightness variation is determined by using color attributes, a brightness variation of image data after motion compensation can be compensated for. In addition, inter prediction or intra prediction can be performed based on an inter prediction mode or an intra prediction mode determined by using texture attributes. In addition, frequency transform can be performed by using a window length determined using speed attributes of sound.

According to an encoding scheme according to an exemplary embodiment, attribute information for management or search of multimedia can be encoded to a multimedia content attribute descriptor. For example, color attributes of image data can be encoded to at least one of metadata regarding a color layout, metadata regarding a color structure, and metadata regarding a scalable color. Texture attributes of image data can be encoded to at least one of metadata regarding an edge histogram, metadata for texture browsing, and metadata regarding homogeneity of texture. Speed attributes of sound data can be encoded to at least one of metadata regarding audio tempo, semantic description information, and side information.

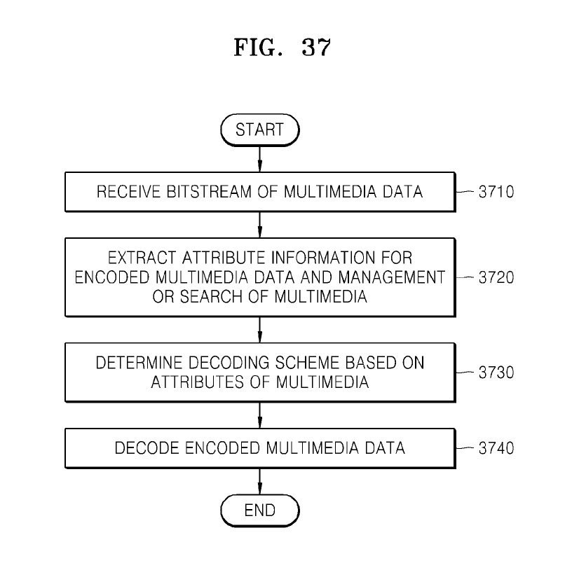

FIG. 37 is a flowchart of a multimedia decoding method, according to an exemplary embodiment.

Referring to FIG. 37, in operation 3710, a bitstream of multimedia data is received, parsed, and classified into encoded multimedia data and information regarding the multimedia. The multimedia can include all kinds of data, such as image and sound data. The information regarding the multimedia can include metadata and a content attribute descriptor.

In operation 3720, attribute information for management or search of multimedia is extracted from the encoded multimedia data and information regarding the multimedia. The attribute information for management or search of multimedia can be extracted from a descriptor for management and search based on the attributes of multimedia content.

For example, color attributes of image data can be extracted from at least one of metadata regarding a color layout, metadata regarding a color structure, and metadata regarding a scalable color. Texture attributes of image data can be extracted from at least one of metadata regarding an edge histogram, metadata for texture browsing, and metadata regarding homogeneity of texture. Speed attributes of sound data can be extracted from at least one of metadata regarding audio tempo, semantic description information, and side information.

The color attributes of image data can include a color layout and a color histogram of an image. The texture attributes of image data can include homogeneity, smoothness, regularity, edge orientation, and coarseness of image texture. The speed attributes of sound data can include tempo information of sound.

In operation 3730, an encoding scheme based on attributes of multimedia is determined by using the attribute information for management or search of multimedia. For example, a compensation value of a brightness variation can be determined based on the color attributes of image data. A data processing unit size and a prediction mode used in inter prediction can be determined based on the texture attributes of image data. A type and direction of available intra prediction can be determined based on the texture attributes of image data. A length of a window for frequency transform can be determined based on the speed attributes of sound data.

In operation 3740, the encoded multimedia data is decoded. The encoded multimedia data is decoded according to a decoding scheme based on attributes of multimedia. The decoding of multimedia data passes through motion estimation, motion compensation, intra prediction, inverse frequency transform, dequantization, and entropy decoding. Multimedia content can be restored by decoding the multimedia data.

According to the multimedia decoding method according to an exemplary embodiment, at least one of motion estimation, motion compensation, intra prediction, inverse frequency transform, dequantization, and entropy decoding can be performed by considering the attributes of multimedia content. For example, if a compensation value of a brightness variation is determined by using color attributes, a brightness variation of image data after motion compensation can be compensated for. In addition, inter prediction or intra prediction can be performed based on an inter prediction mode or an intra prediction mode determined by using texture attributes. In addition, inverse frequency transform can be performed by using a window length determined using speed attributes of sound.

The exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs).

While the exemplary embodiments have been shown and described, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description but by the appended claims, and all differences within the scope will be construed as being included in the present invention.

1. A method of encoding multimedia data based on attributes of multimedia content, the method comprising:
receiving the multimedia data;
detecting attribute information of the multimedia data based on the attributes of the multimedia content; and
determining an encoding scheme of encoding the multimedia data based on the detected attribute information.

2. The method of claim 1, further comprising:
encoding the multimedia data according to the encoding scheme; and
generating a bitstream comprising the encoded multimedia data.

3. The method of claim 2, further comprising encoding the attribute information of the multimedia data as a descriptor for management or search of the multimedia data,
wherein the generating of the bitstream comprises generating a bitstream comprising the encoded multimedia data and the descriptor.

4. The method of claim 1, wherein the predetermined attributes comprise at least one of color attributes of image data, texture attributes of image data, and speed attributes of sound data, and
wherein the detecting of the attribute information comprises detecting at least one of the color attributes of image data, the texture attributes of image data, and the speed attributes of sound data.

5. The method of claim 4, wherein the color attributes of image data comprises at least one of a color layout of an image and an accumulated distribution per color bin.

6. The method of claim 4, wherein the determining the encoding scheme comprises measuring a variation between a pixel value of current image data and a pixel value of reference image data by using the color attributes of the image data.

7. The method of claim 6, wherein the determining the encoding scheme further comprises compensating for the pixel value of the current image data by using the variation between the pixel value of the current image data and the pixel value of the reference image data.

8. The method of claim 7, further comprising compensating for the variation of the pixel values for the current image data for which motion compensation has been performed and encoding the current image data.

9. The method of claim 4, wherein the texture attributes of the image data comprises at least one of homogeneity, smoothness, regularity, edge orientation, and coarseness of image texture.

10. The method of claim 9, wherein the determining of the encoding scheme comprises determining a size of a data processing unit for motion estimation of current image data by using the texture attributes of the image data.

11. The method of claim 10, wherein the determining the encoding scheme comprises determining the size of the data processing unit based on at least one of the homogeneity, the smoothness, and the regularity of the texture attributes of the image data so that a texture change of the current image decreases as the size of the data processing unit increases.

12. The method of claim 10, further comprising performing motion estimation or motion compensation for the current image data by using the data processing unit of which the size is determined for the image data.

13. The method of claim 9, wherein the determining the encoding scheme comprises determining a predictable intra prediction mode for the current image data by using the texture attributes of the image data.

14. The method of claim 13, wherein the determining the encoding scheme comprises determining a type and a priority of a predictable intra prediction mode for the current image data based on the edge orientation of the texture attributes of the image data.

15. The method of claim 13, further comprising performing motion estimation for the current image data by using the intra prediction mode determined for the current image data.

16. The method of claim 4, wherein the determining the encoding scheme comprises determining a length of a data processing unit for frequency transform of current sound data by using the speed attributes of the sound data.

17. The method of claim 16, wherein the determining the encoding scheme comprises determining the length of the data processing unit to decrease as the current sound data increases, based on the tempo information of the speed attributes of the sound data.

18. The method of claim 17, further comprising performing frequency transform for the current sound data by using the data processing unit of which the length is determined for the sound data.

19. The method of claim 4, further comprising:
encoding at least one of metadata regarding a color layout, metadata regarding a color structure, and metadata regarding a scalable color as a descriptor for management or search of the multimedia based on the multimedia content if the predetermined attributes of the multimedia content are the color attributes of the image data;
encoding at least one of metadata regarding an edge histogram, metadata for texture browsing, and metadata regarding homogeneity of texture as the descriptor for management or search of the multimedia based on the multimedia content if the predetermined attributes of the multimedia content are the texture attributes of the image data; and
encoding at least one of metadata regarding audio tempo, semantic description information, and side information as the descriptor for management or search of the multimedia based on the multimedia content if the predetermined attributes of the multimedia content are the speed attributes of the sound data.

20. A method of decoding multimedia data based on attributes of multimedia content, the method comprising:
receiving a bitstream of encoded multimedia data;
parsing the received bitstream;
classifying encoded data of the multimedia data and information regarding the multimedia data based on the parsed bitstream;
extracting attribute information for management or search of the multimedia data from the information regarding the multimedia; and
determining a decoding scheme of decoding the multimedia data based on the extracted.

21. The method of claim 20, further comprising:
decoding the encoded data of the multimedia according to the decoding scheme; and
restoring the decoded multimedia data as the multimedia data.

22. The method of claim 20, wherein the extracting the attribute information comprises:
extracting a descriptor for management or search of the multimedia based on the multimedia content; and
extracting the attribute information from the descriptor.

23. The method of claim 20, wherein the predetermined attributes comprise at least one of color attributes of image data, texture attributes of image data, and speed attributes of sound data, and
wherein the extracting of the attribute information comprises extracting at least one of the color attributes of image data, the texture attributes of image data, and the speed attributes of sound data.

24. The method of claim 23, wherein the color attributes of image data comprises at least one of a color layout of an image and an accumulated distribution per color bin.

25. The method of claim 23, wherein the determining of the decoding scheme comprises measuring a variation between a pixel value of current image data and a pixel value of reference image data by using the color attributes of the image data.

26. The method of claim 25, further comprising:
performing motion compensation of inverse-frequency-transformed current image data; and
compensating for the pixel value of the current image data for which the motion compensation has been performed by using the variation between the pixel value of the current image data and the pixel value of the reference image data.

27. The method of claim 23, wherein the texture attributes of the image data comprises at least one of homogeneity, smoothness, regularity, edge orientation, and coarseness of image texture.

28. The method of claim 27, wherein the determining of the decoding scheme comprises determining a size of a data processing unit for motion estimation of current image data by using the texture attributes of the image data.

29. The method of claim 28, wherein the determining the decoding scheme comprises determining the size of the data processing unit based on at least one of the homogeneity, the smoothness, and the regularity of the texture attributes of the image data so that a texture change of the current image decreases as the more the size of the data processing unit increases.

30. The method of claim 28, further comprising performing motion estimation or motion compensation for the current image data by using the data processing unit of which the size is determined for the image data.

31. The method of claim 23, wherein the determining the decoding scheme comprises determining a predictable intra prediction mode for the current image data by using the texture attributes of the image data.

32. The method of claim 31, wherein the determining the decoding scheme comprises determining a type and a priority of a predictable intra prediction mode for the current image data based on edge orientation of the texture attributes of the image data.

33. The method of claim 31, further comprising performing motion estimation for the current image data by using the intra prediction mode determined for the current image data.

34. The method of claim 22, wherein speed attributes of sound data comprises tempo information of sound.

35. The method of claim 22, wherein the determining of the decoding scheme comprises determining a length of a data processing unit for inverse frequency transform of current sound data by using the speed attributes of the sound data.

36. The method of claim 35, wherein the determining the decoding scheme comprises determining the length of the data processing unit to decrease as the current sound data increases, based on the tempo information of the speed attributes of the sound data.

37. The method of claim 35, further comprising performing inverse frequency transform for the current sound data by using the data processing unit of which the length is determined for the sound data.

38. The method of claim 31, wherein the extracting of the attribute information comprises:
extracting at least one of metadata regarding a color layout, metadata regarding a color structure, metadata regarding a scalable color, metadata regarding an edge histogram, metadata for texture browsing, metadata regarding homogeneity of texture, metadata regarding audio tempo, semantic description information, and side information from the descriptor by parsing the bitstream; and
if the extracted descriptor is at least one of the metadata regarding a color layout, the metadata regarding a color structure, and the metadata regarding a scalable color, extracting the color attributes of the image data from the extracted descriptor,
if the extracted descriptor is at least one of the metadata regarding an edge histogram, the metadata for texture browsing, and the metadata regarding homogeneity of texture, extracting the texture attributes of the image data from the extracted descriptor, and
if the extracted descriptor is at least one of the metadata regarding audio tempo, the semantic description information, and the side information, extracting the speed attributes of the sound data from the extracted descriptor.

39. An apparatus that encodes multimedia data based on attributes of multimedia content, the apparatus comprising:
an input unit that receives the multimedia data;
an attribute information detector that detects attribute information of the multimedia data based on the attributes of the multimedia content;
an encoding scheme determiner that determines an encoding scheme of encoding the multimedia data based on the detected attribute information; and
a multimedia data encoder that encodes the multimedia data according to the encoding scheme.

40. The apparatus of claim 39, further comprising a descriptor encoder that encodes the attribute information for management or search of the multimedia into a descriptor.

41. The apparatus of claim 40, wherein the attribute information includes at least one of color attributes of image data, texture attributes of image data, and speed attributes of sound data, and
the descriptor includes at least one of metadata regarding a color layout, metadata regarding a color structure, metadata regarding a scalable color, metadata regarding an edge histogram, metadata for texture browsing, and metadata regarding homogeneity of texture of the image data and the speed attributes of sound data.

42. An apparatus for decoding multimedia data based on attributes of multimedia content, the apparatus comprising:
a receiver that receives a bitstream of encoded multimedia data, parses the received bitstream, and classifies encoded multimedia data and information regarding the multimedia based on the parsed bitstream;
an attribute information extractor that extracts attribute information for management or search of the multimedia data from the information regarding the multimedia;
a decoding scheme determiner that determines a decoding scheme of decoding the multimedia data based on the extracted attribute information; and
a multimedia data decoder that decodes the encoded multimedia data according to the decoding scheme.

43. The apparatus of claim 42, further comprising a restorer that restores the decoded multimedia data as the multimedia data.

44. The apparatus of claim 42, wherein the attribute information extractor extracts a descriptor for management or search of the multimedia by parsing the bitstream and extracts the attribute information from the descriptor,
the attribute information includes at least one of color attributes of image data, texture attributes of image data, and speed attributes of sound data, and
the descriptor includes at least one of metadata regarding a color layout, metadata regarding a color structure, metadata regarding a scalable color, metadata regarding an edge histogram, metadata for texture browsing, and metadata regarding homogeneity of texture of the image data and the speed attributes of sound data.

45. A computer readable recording medium storing a computer readable program for executing the method of claim 1.

46. A computer readable recording medium storing a computer readable program for executing the method of claim 20.
